(19) United States
(12) Patent Application Publication
(10) Pub. No.: US 2026/0115720 A1
(43) Pub. Date: Apr. 30, 2026

(54) MEASUREMENT UNIT AND METHOD FOR MANUFACTURING MEASUREMENT UNIT

(71) Applicant: HAMAMATSU PHOTONICS K.K., Hamamatsu-shi (JP)

(72) Inventors: Kimiko KAZUMURA, Shizuoka (JP); Yoshinao NAGAI, Shizuoka (JP); Kumi AKITA, Shizuoka (JP)

(73) Assignee: HAMAMATSU PHOTONICS K.K., Hamamatsu-shi (JP)

(21) Appl. No.: 19/365,388

(22) Filed: Oct. 22, 2025

(30) Foreign Application Priority Data
Oct. 25, 2024 (JP) 2024-188511

(51) Int. Cl. B01L 3/00

(52) U.S. Cl. CPC B01L 3/50273; B01L 3/502707; B01L 2200/0689; B01L 2200/12; B01L 2200/16; B01L 2300/10; B01L 2300/14

(57) ABSTRACT

A measurement unit is used for measuring a characteristic of a biological sample. The measurement unit includes a second solution containing a stimulant configured to activate a function of the biological sample and an organic solvent configured to dissolve the stimulant, a second container configured to house the frozen second solution, and a sealing bag configured to house the second container in its sealed internal space.

### CROSS REFERENCE TO RELATED APPLICATION

The present application claims priority based on Japanese Patent Application No. 2024-188511 filed on Oct. 25, 2024, the entire contents of which are incorporated herein by reference.

### TECHNICAL FIELD

The present disclosure relates to a measurement unit and a method for manufacturing a measurement unit.

### BACKGROUND

Conventionally, a technique for measuring a characteristic of a biological sample has been known (e.g., see Japanese Unexamined Patent Publication No. 2019-213464). In such a technique, the characteristic of the biological sample may be measured by adding a biological sample collected from a subject (e.g., human body) to a prepared solution by introducing a plurality of reagents into a container and then measuring light generated in an internal space of the container.

### SUMMARY

In the technique described above, at least one of the plurality of reagents may deteriorate at room temperature. In this case, it is desirable to perform operations such as the preparation of the prepared solution and the introduction of the prepared solution into the container immediately before the optical measurement and in the vicinity of the subject. However, when these operations are performed in the vicinity of the subject, the operations may become cumbersome.

The present disclosure provides a measurement unit and a method for manufacturing a measurement unit capable of maintaining quality of a solution and enabling simple operations.

A measurement unit of the present disclosure is [1] “a measurement unit used for measuring a characteristic of a biological sample, and including a solution containing a stimulant configured to activate a function of the biological sample and an organic solvent configured to dissolve the stimulant; a container configured to house the frozen solution; and a sealing bag configured to house the container in its sealed internal space”.

In the measurement unit, the solution containing the stimulant configured to activate the function of the biological sample is housed in the container in a frozen state. In this case, the measurement unit can be carried in the vicinity of a subject in a state where the solution is frozen. After thawing the solution in the vicinity of the subject, the thawed solution can be added to the solution to which the biological sample is to be added. Thus, not only is the quality of the solution housed in the container maintained, but an operation such as introduction of the solution into the container also becomes unnecessary in the vicinity of the subject. Furthermore, the above measurement unit includes a sealing bag for housing the container in a sealed internal space. The organic solvent contained in the solution may have hygroscopicity of absorbing moisture in the air. In this case, when the stimulant contained in the solution is dissolved by the organic solvent, hydrolysis of the stimulant may proceed. This can cause the stimulant to lose activity and deteriorate the quality of the solution. In contrast, when the container is housed in the sealed internal space of the sealing bag as in the measurement unit described above, moisture in the air around the container can be prevented from being absorbed by the solution. This makes it possible to suppress deterioration in the quality of the solution due to the progress of hydrolysis. Accordingly, according to the above-described measurement unit, the quality of the solution is maintained, and the operation for measuring the characteristic of the biological sample is simplified.

The measurement unit of the present disclosure may be [2] “the measurement unit according to [1],further including a sealing member configured to close at least one of a first opening formed in the container and a second opening formed in the container at a position different from the first opening”. In this case, it is possible to prevent moisture in the air from being absorbed into the solution, so that it is possible to suppress deterioration of the quality of the solution due to the progress of hydrolysis.

The measurement unit of the present disclosure may be [3] “the measurement unit according to [1], further including: a first sealing member configured to close a first opening formed in the container; and a second sealing member configured to close a second opening formed in the container at a position different from the first opening”. In this case, the interior of the container can be sealed by the first sealing member and the second sealing member. This can effectively prevent moisture in the air around the container from being absorbed by the solution inside the container.

The measurement unit of the present disclosure may be [4] “the measurement unit according to any one of [1] to [3], further including a moisture absorbent that is housed in the internal space of the sealing bag together with the container and absorbs moisture in the air”. In this case, since the moisture in the air can be absorbed by the moisture absorbent, it is possible to effectively prevent the moisture from being absorbed by the solution inside the container.

The measurement unit of the present disclosure may be [5] “the measurement unit according to any one of [1] to [4], wherein one said containers is housed in the internal space of the sealing bag. ”. In this case, the measurement unit can be realized with a simple configuration.

The measurement unit of the present disclosure may be [6] “the measurement unit according to any one of [1] to [4], further including a plurality of said containers each housing the frozen solution, wherein a plurality of said containers are housed in the internal space of the sealing bag”. In this case, when the frozen containers are mass-produced, the plurality of containers are collectively housed in the internal space of the sealing bag, whereby the cost required for the production, transportation, and the like of the measurement unit can be reduced.

The measurement unit of the present disclosure may be [7] “the measurement unit according to any one of [1] to [6], further including a first solution containing an indicator configured to react with a component generated from the biological sample; and a first container configured to house the first solution, wherein the sealing bag houses the first container configured to house the first solution and a second container that is the container housing a second solution that is the solution in the internal space”. In this case, for example, by housing the first solution in the first container in a frozen state, the measurement unit can be carried in the vicinity of the subject in a state where the first solution is frozen, and the biological sample collected from the subject can be added to the first solution after the first solution is thawed in the vicinity of the subject. Thus, not only is the quality of the first solution maintained, but operations such as preparation of the first solution and introduction of the first solution into the first container also become unnecessary in the vicinity of the subject. Therefore, according to the configuration of [7], the qualities of the first solution and the second solution are maintained, and the operation for measuring the characteristic of the biological sample is simplified. Furthermore, in the configuration of [7], since the first container and the second container can be transported together using one sealing bag, it is possible to reduce the transportation cost of the measurement unit and improve the usability as compared with the case where the first container and the second container are housed in different sealing bags and transported.

The measurement unit of the present disclosure may be [8] “the measurement unit according to any one of [1] to [6], further comprising: a first solution containing at least one of physiological saline and a buffer solution; a first container configured to house the first solution; a third solution containing an indicator configured to react with a component generated from the biological sample; and a third container configured to house the third solution, wherein the sealing bag houses the first container configured to house the first solution, a second container that is the container housing a second solution that is the solution, and the third container configured to house the third solution in the internal space”. In this manner, when the first solution containing at least one of physiological saline and a buffer solution and the third solution containing the indicator are housed in separate containers in the internal space of the sealing bag, the quality of the solution housed in each container is less likely to deteriorate than in a case where physiological saline, a buffer solution, and an indicator are housed in one container, so that the quality of the solution can be more reliably maintained.

The measurement unit of the present disclosure may be [9] “the measurement unit according to the above [7] or [8], wherein the indicator is a fluorescent indicator”. A solution containing a fluorescent indicator may require cryopreservation. As described above, when the first solution containing the fluorescent indicator is frozen, the cryopreservation of the first solution containing the fluorescent indicator is realized.

The measurement unit of the present disclosure may be [10] “the measurement unit according to any one of [1] to [9], wherein the organic solvent is dimethyl sulfoxide (DMSO)”. DMSO has high hygroscopicity. Therefore, it is assumed that when the stimulant contained in the solution is dissolved by the DMSO, hydrolysis of the stimulant may proceed. In contrast, in the measurement unit, as described above, moisture in the air around the container can be prevented from being absorbed by the solution. This makes it possible to suppress deterioration in the quality of the solution due to the progress of hydrolysis, so that the above-described effect can be exhibited.

A measurement unit of the present disclosure is [11] “a measurement unit used for measuring a characteristic of a biological sample, and including a stimulant configured to activate a function of the biological sample; a container configured to house the frozen stimulant; and a sealing bag configured to house the container in its sealed internal space”.

In the measurement unit, the frozen stimulant is housed in a container housed in the sealed internal space of the sealing bag. There is concern that the stimulant may undergo hydrolysis depending on humidity. Therefore, when the container is housed in the internal space of the sealing bag as in the measurement unit described above, moisture in the air around the container can be prevented from being absorbed by the stimulant, and thus it is possible to suppress deterioration in quality of the stimulant due to the progress of hydrolysis. Therefore, according to the measurement unit, the same effect as the above [1] can be obtained.

A method for manufacturing a measurement unit of the present disclosure is [12] “a method for manufacturing a measurement unit for measuring a characteristic of a biological sample, the method including: preparing a solution containing a stimulant configured to activate a function of the biological sample and an organic solvent configured to dissolve the stimulant, a container capable of housing the solution, and a sealing bag capable of housing the container; freezing the solution in a state of being housed in the container; and sealing an internal space of the sealing bag in a state where the container is housed in the internal space.

According to the method for manufacturing the measurement unit described above, it is possible to manufacture the measurement unit that exhibits the effect of [1] described above.

The method for manufacturing a measurement unit of the present disclosure may be [13] “the method for manufacturing a measurement unit according to [12], wherein in the freezing the solution, the solution is frozen in a state where a first opening formed in the container is closed with a first sealing member and a second opening formed in the container at a position different from the first opening is closed with a second sealing member”. In this case, the solution inside the container can be frozen in a state where the interior of the container is sealed by the first sealing member and the second sealing member. This can effectively prevent moisture in the air around the container from being absorbed by the solution inside the container.

The method for manufacturing a measurement unit of the present disclosure may be [14] “the method for manufacturing a measurement unit according to [12] or [13], wherein in the sealing the internal space of the sealing bag, the internal space is sealed in a state where a moisture absorbent that absorbs moisture in the air is housed in the internal space together with the container”. In this case, in the sealing the internal space of the sealing bag, since the moisture in the air can be absorbed by the moisture absorbent, it is possible to effectively prevent the moisture from being absorbed by the solution inside the container.

The method for manufacturing a measurement unit of the present disclosure may be [15] “the method for manufacturing a measurement unit according to any one of [12] to [14], further including housing a first solution containing an indicator configured to react with a component generated from the biological sample in a first container, wherein in the sealing the internal space of the sealing bag, the internal space is sealed in a state where the first container configured to house the first solution and a second container that is the container configured to house a second solution that is the solution are housed in the internal space”. In this case, as described above, for example, by housing the first solution in the first container in a frozen state, the measurement unit can be carried in the vicinity of the subject in a state where the first solution is frozen. After thawing the first solution in the vicinity of the subject, the biological sample collected from the subject can be added to the first solution. Thus, not only is the quality of the first solution maintained, but operations such as preparation of the first solution and introduction of the first solution into the first container also become unnecessary in the vicinity of the subject. Therefore, according to the configuration of [15], the qualities of the first solution and the second solution are maintained, and the operation for measuring the characteristic of the biological sample is simplified. Furthermore, in the configuration of [15], since the first container and the second container can be transported together using one sealing bag, it is possible to reduce the transportation cost of the measurement unit and improve the usability as compared with the case where the first container and the second container are housed in different sealing bags and transported.

The method for manufacturing a measurement unit of the present disclosure may be [16] “the method for manufacturing a measurement unit according to [12], further comprising: housing a first solution containing at least one of physiological saline and a buffer solution in a first container; and housing a third solution containing an indicator configured to react with a component generated from the biological sample in a third container, wherein in the sealing the internal space of the sealing bag, the internal space is sealed in a state where the first container configured to house the first solution, a second container that is the container configured to house a second solution that is the solution, and the third container configured to house the third solution are housed in the internal space”. In this manner, when the first solution containing at least one of physiological saline and a buffer solution and the third solution containing the indicator are housed in separate containers in the internal space of the sealing bag, the quality of the solution housed in each container is less likely to deteriorate than in a case where physiological saline, a buffer solution, and an indicator are housed in one container, so that the quality of the solution can be more reliably maintained.

The method for manufacturing a measurement unit of the present disclosure may be [17] “the method for manufacturing a measurement unit according to any one of [12] to [16], wherein, except during the preparing the solution and introducing the solution into the container, temperature around the container is maintained at a freezing point of the organic solvent or less”. In this case, the temperature around the container is maintained at temperature equal to or lower than the freezing point of the organic solvent, whereby the progress of hydrolysis of the stimulant by the organic solvent can be suppressed. This makes it possible to suppress deterioration in the quality of the solution due to the progress of hydrolysis.

The method for manufacturing a measurement unit of the present disclosure may be [18] “the method for manufacturing a measurement unit according to any one of [12] to [17], wherein in the freezing the solution, the solution is frozen in a state where a moisture absorbent that absorbs moisture in the air is disposed around the container”. In this case, in the freezing the solution, since the moisture in the air can be absorbed by the moisture absorbent, it is possible to effectively prevent the moisture from being absorbed by the solution inside the container.

The method for manufacturing a measurement unit of the present disclosure may be [19] “the method for manufacturing a measurement unit according to any one of [12] to [18], wherein in the sealing the internal space of the sealing bag, the internal space of the sealing bag is sealed in a state where the atmosphere of the internal space is replaced with a nitrogen atmosphere”. In this case, since the humidity of the internal space of the sealing bag can be reduced, the moisture in the internal space can be effectively reduced from being absorbed by the solution inside the container.

The method for manufacturing a measurement unit of the present disclosure may be [20] “the method for manufacturing a measurement unit according to any one of [12] to [18], wherein in the sealing the internal space of the sealing bag, the internal space of the sealing bag is sealed in a state where the internal space is maintained under vacuum”. In this case, since the humidity of the internal space of the sealing bag can be reduced, the moisture in the internal space can be effectively reduced from being absorbed by the solution inside the container.

According to the present disclosure, it is possible to provide a measurement unit and a method for manufacturing a measurement unit, capable of maintaining quality of a solution and enabling simple operations.

### BRIEF DESCRIPTION OF THE DRAWINGS

FIG. 1 is a front view of a measurement unit according to an embodiment.

FIG. 2 is a front view illustrating a first measurement kit of FIG. 1.

FIG. 3 is a cross-sectional view of the first measurement kit taken along line III-III of FIG. 2.

FIG. 4 is a cross-sectional view of the first measurement kit taken along line IV-IV in FIG. 3.

FIG. 5 is a cross-sectional view of the first measurement kit taken along line V-V in FIG. 4.

FIG. 6 is a cross-sectional view of a second measurement kit of FIG. 1.

FIG. 7 is an enlarged cross-sectional view of a part of the second measurement kit of FIG. 6.

FIG. 8 is a flowchart illustrating steps of a method for manufacturing the measurement unit of FIG. 1.

FIG. 9A is a side view illustrating a cold storage box for maintaining a second solution at a certain temperature or lower.

FIG. 9B is a side view illustrating an example of the cold storage box.

FIG. 9C is a side view illustrating another example of the cold storage box.

FIG. 10 is a schematic view illustrating a step of freezing the second solution.

FIG. 11 is a schematic view illustrating a step of housing the first measurement kit, the second measurement kit, and the moisture absorbent in a sealing bag.

FIG. 12 is a schematic cross-sectional view illustrating a measurement device.

FIG. 13 is a schematic cross-sectional view illustrating a measurement device.

FIG. 14 is a flowchart illustrating steps of a biological sample measurement method using the measurement unit illustrated in FIG. 1.

FIG. 15 is a front view illustrating an example of the measurement unit.

FIG. 16 is a front view illustrating another example of the measurement unit.

FIG. 17 is a cross-sectional view illustrating a third container of FIG. 16.

FIG. 18 is a flowchart illustrating steps of a method for manufacturing the measurement unit of FIG. 16.

### DETAILED DESCRIPTION

Hereinafter, an embodiment of the present disclosure will be described in detail with reference to the drawings. In the drawings, the same or corresponding parts are denoted by the same reference signs, and redundant description will be omitted.

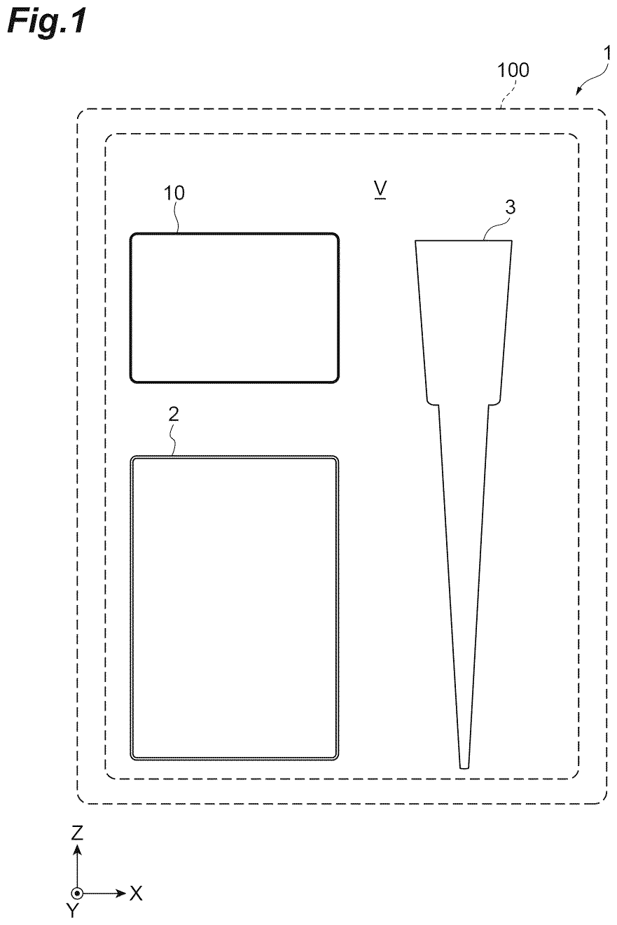

A measurement unit 1 illustrated in FIG. 1 is used for measuring a characteristic of a biological sample. The biological sample is, for example, blood (e.g., whole blood) of a subject (e.g., living organism. The subject is, for example, a human body. In the present embodiment, the subject is a patient in a hospital. The biological sample contains, for example, white blood cells. The characteristic of the biological sample is, for example, an activity of white blood cells. In the present embodiment, the characteristic of the biological sample is an activity of a neutrophil.

The neutrophil is a type of white blood cell. A main role of the neutrophil is to prevent infection by phagocytizing and killing bacteria and fungi that have entered the body. The neutrophil takes up bacteria and the like into itself by wrapping the bacteria and the like with its plasma membrane. As a result, phagosome is formed. When the f phagosome fuses with a granule, the granule contents are released into the phagosome. Reactive Oxygen Species (superoxide, hydrogen peroxide) is generated by an NADPH oxidase system formed in a cell membrane (the membrane of the phagosome), and the reactive oxygen species sterilizes bacteria and the like. Hypochlorous acid (HOCl) (or halogen equivalent thereof) is produced from hydrogen peroxide (H₂O₂) and chlorine ion (Cl⁻) by an enzymatic reaction of myeloperoxidase (EC number 1.11.2.2) contained in the granule contents, and the hypochlorous acid sterilizes bacteria and the like. Accordingly, a myeloperoxidase activity or a superoxide production activity is used as an index for evaluating the activity of the neutrophil. The measurement unit 1 of the present embodiment is used for measuring the myeloperoxidase activity or the superoxide production activity.

As illustrated in FIG. 1, the measurement unit 1 includes a first measurement kit 2, a second measurement kit 3, a moisture absorbent 10, and a sealing bag 100. The first measurement kit 2, the second measurement kit 3, and the moisture absorbent 10 are housed in an internal space V of the sealing bag 100. The internal space V of the sealing bag 100 is sealed in a state where the first measurement kit 2, the second measurement kit 3, and the moisture absorbent 10 are housed. The fact that the internal space V is sealed means that the internal space V is airtightly closed so that air from outside the sealing bag 100 does not enter the internal space V. By sealing the internal space V, exposure of the first measurement kit 2 and the second measurement kit 3 arranged in the internal space V to the air outside the sealing bag 100, that is, contact of the first measurement kit 2 and the second measurement kit 3 with moisture in the air outside is reduced.

The sealing bag 100 is, for example, a metal bag (e.g., an aluminum bag) formed of metal such as aluminum. When the sealing bag 100 is an aluminum bag formed of aluminum, since the aluminum bag has a high light shielding property, it is possible to suppress a temperature rise of the aluminum bag itself or the internal space V, and it is possible to suppress an increase in hygroscopicity due to a temperature rise of the second solution 8 contained in the second measurement kit 3. Since the aluminum bag has high moisture resistance, an increase in humidity of the internal space V can be suppressed even when the storage period is long. Since the aluminum bag has a high thermal conductivity, it is possible to suppress an increase in hygroscopicity due to a temperature rise of the second solution 8 during the frozen storage including transportation. As a result, the aluminum bag can suppress deterioration of the characteristics of the second solution 8. The material of the sealing bag 100 may be another material.

The moisture absorbent 10 has hygroscopicity to absorb moisture in the surrounding air. In the sealed internal space V, the moisture absorbent 10 absorbs moisture in the air present in the internal space V. Therefore, in the sealed internal space V, contact of the first measurement kit 2 and the second measurement kit 3 with moisture in the air is reduced. The moisture absorbent 10 is, for example, a desiccant formed of zeolite or the like. The moisture absorbent 10 may be a dehumidifying agent or a water absorbent. The form of the moisture absorbent 10 may be any of a sheet, granules, a mass, fibers, and a sphere.

The sealing bag 100 may also serve as the moisture absorbent 10. That is, the material of the sealing bag 100 may include the material of the moisture absorbent 10. In this case, since the sealing bag 100 has a function as the moisture absorbent 10, it is not necessary to house the moisture absorbent 10 in the internal space V of the sealing bag 100.

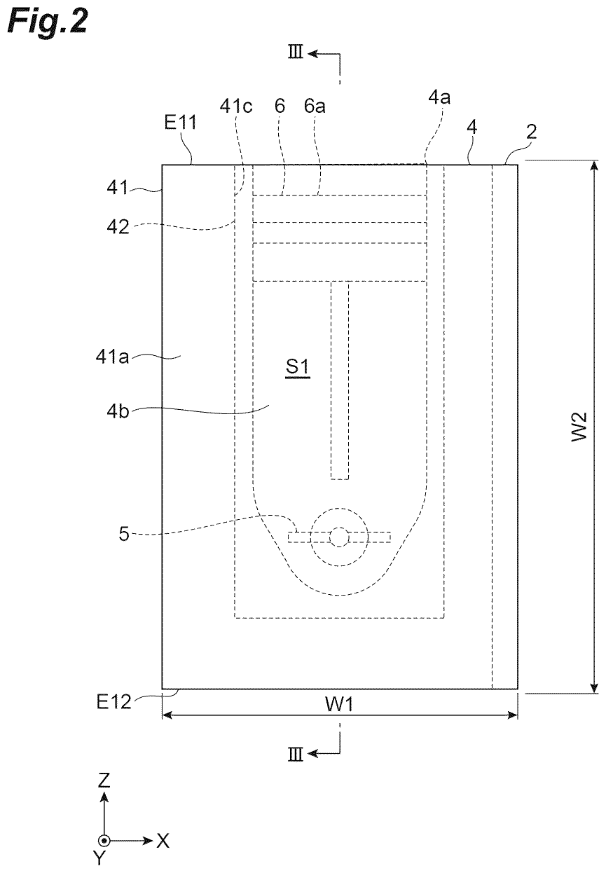

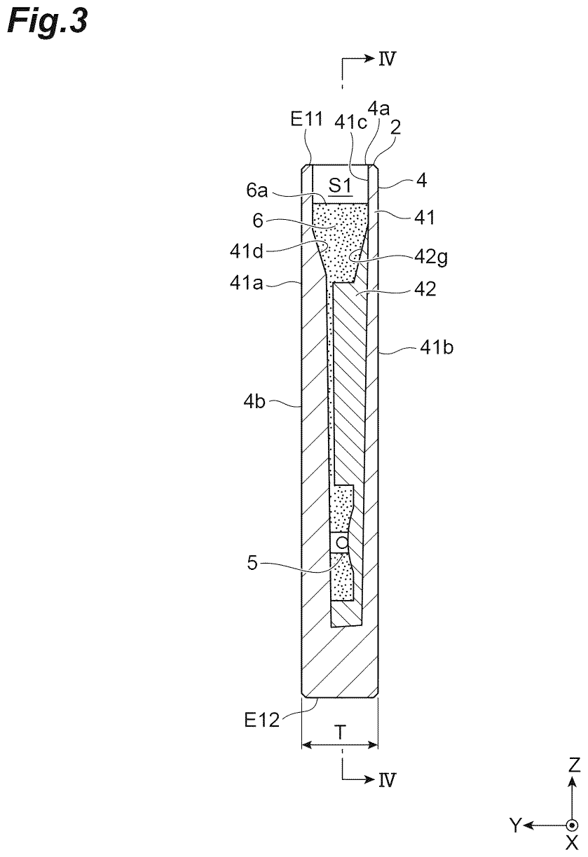

As illustrated in FIGS. 2 and 3, the first measurement kit 2 includes a first container 4, a rotor 5, and a first solution 6. The first container 4 has, for example, a rectangular plate shape. The first container 4 includes a first internal space S1 and an opening 4a. The opening 4a opens into the first internal space S1.

A thickness T of the first container 4 (i.e., a length of the first container 4 in a Y-axis direction) is smaller than a width W1 of the first container 4 (i.e., a length of the first container 4 in an X-axis direction). The thickness T of the first container 4 is, for example, ⅓ or less of the width W1 of the first container 4. The thickness T of the first container 4 is smaller than a height W2 of the first container 4 (i.e., a length of the first container 4 in a Z-axis direction). The thickness T of the first container 4 is, for example, ⅓ or less of the height W2 of the first container 4. The height W2 of the first container 4 is larger than the width W1 of the first container 4. The height W2 of the first container 4 is, for example, 1.1 times or more the width W1 of the first container 4. The thickness T of the first container 4 is, for example, 6 mm. The width W1 of the first container 4 is, for example, 28 mm. The height W2 of the first container 4 is, for example, 41 mm.

The first container 4 includes a first member 41 and a second member 42. The first member 41 has, for example, a rectangular plate shape. The first member 41 includes principal surfaces 41a and 41b and an internal space 41c. The principal surface 41a and the principal surface 41b are opposite to each other in the Y-axis direction (i.e., a thickness direction of the first container 4). The internal space 41c opens at a first end E11 of the first member 41 in the Z-axis direction (i.e., a height direction of the first container 4). The internal space 41c reaches the first end E11 of the first member 41 in the Z-axis direction and does not reach a second end E12 of the first member 41 in the Z-axis direction. The internal space 41c has, for example, a rectangular shape as viewed in the Y-axis direction.

The first member 41 includes a recess 41d. The recess 41d is formed at the first end E11 of the first member 41 in the Z-axis direction. The recess 41d forms an opening 4a at the first end E11 of the first member 41 in the Z-axis direction. The recess 41d extends from the opening 4a in the Z-axis direction. A width of the recess 41d in the X-axis direction is smaller than a maximum width of the internal space 41c in the X-axis direction. Both ends of the recess 41d in the X-axis direction are positioned inside both ends of the internal space 41c in the X-axis direction.

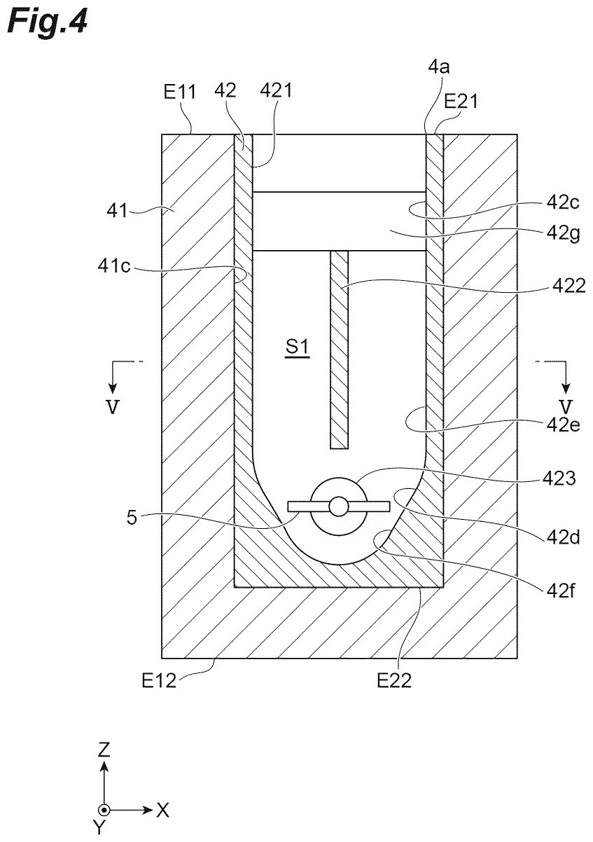

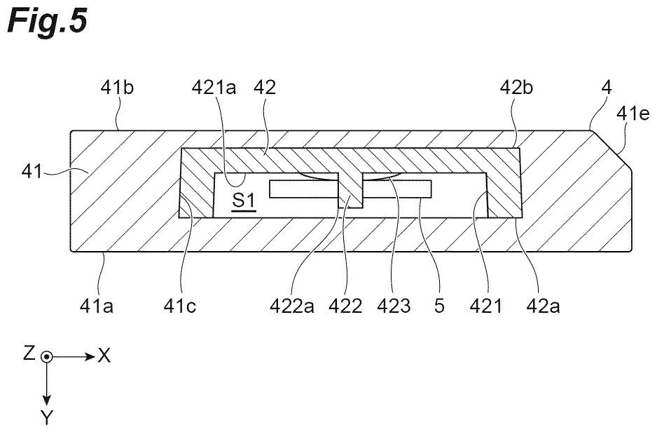

The second member 42 is disposed in the internal space 41c of the first member 41. As illustrated in FIGS. 4 and 5, the second member 42 has, for example, a rectangular plate shape. An outer shape of the second member 42 matches a shape of the internal space 41c. Specifically, a width of the second member 42 in the X-axis direction is the same as a width of the internal space 41c in the X-axis direction. A width of the second member 42 in the Y-axis direction is the same as a width of the internal space 41c in the Y-axis direction. A width of the second member 42 in the Z-axis direction is the same as a width of the internal space 41c in the Z-axis direction.

As illustrated in FIG. 5, the second member 42 includes principal surfaces 42a and 42b, a recess 421, a partition wall 422, and a support 423. The principal surface 42a and the principal surface 42b are opposite each other in the Y-axis direction. The principal surface 42a faces the same direction as the principal surface 41a of the first member 41. The principal surface 42a is in contact with the inner surface of the internal space 41c. The principal surface 42b faces the same direction as the principal surface 41b of the first member 41. The principal surface 42b is in contact with the inner surface of the internal space 41c. The recess 421 is formed in the principal surface 42a. As illustrated in FIG. 4, the recess 421 extends to the first end E21 of the second member 42 in the Z-axis direction and does not extend to the second end E22 of the second member 42 in the Z-axis direction.

As illustrated in FIG. 5, the partition wall 422 protrudes from a bottom surface 421a of the recess 421. A height (i.e., a width in the Y-axis direction) of the partition wall 422 is less than a depth of the recess 421. A top surface 422a of the partition wall 422 is positioned between the principal surface 42a and the principal surface 42b. As illustrated in FIG. 4, the partition wall 422 extends along the Z-axis direction as viewed in the Y-axis direction. Both ends of the partition wall 422 in the Z-axis direction are positioned inside of both ends of the recess 421 in the Z-axis direction. The partition wall 422 is a portion of the second member 42.

As illustrated in FIG. 4, the recess 421 includes a first region 42c, a second region 42d, and an intermediate region 42e. The first region 42c is located between the partition wall 422 and the first end E21 of the second member 42 in the Z-axis direction. The first region 42c has, for example, a rectangular shape as viewed in the Y-axis direction. The first region 42c is open at the first end E21 of the second member 42 in the Z-axis direction. The second region 42d is located between the partition wall 422 and the second end E22 of the second member 42 in the Z-axis direction. As viewed in the Y-axis direction, a width of the second region 42d in the X-axis direction gradually decreases from the first end E21 of the second member 42 in the Z-axis direction toward the second end E22. That is, the recess 421 includes a curved inner surface 42f. The inner surface 42f is curved toward a side opposite to the partition wall 422 as viewed in the Y-axis direction.

The intermediate region 42e is positioned between the first region 42c and the second region 42d. The intermediate region 42e is connected to each of the first region 42c and the second region 42d. The intermediate region 42e has, for example, a rectangular shape as viewed in the Y-axis direction. When viewed from the Y-axis direction, a first end of the intermediate region 42e in the Z-axis direction is aligned with a first end of the partition wall 422 in the Z-axis direction. A second end of the intermediate region 42e in the Z-axis direction is aligned with a second end of the partition wall 422 in the Z-axis direction.

The support 423 is positioned in the second region 42d. As illustrated in FIG. 5, the support 423 protrudes from the bottom surface 421a of the recess 421. The surface of the support 423 has, for example, a curved shape. The support 423 is a portion of the second member 42.

As illustrated in FIGS. 3 and 4, the second member 42 includes an inclined region 42g. The inclined region 42g is parallel to the X-axis direction and is inclined with respect to the XZ plane. The inclined region 42g is formed in a region on one side in the Z-axis direction with respect to the partition wall 422 on the bottom surface 421a of the recess 421. The inclined region 42g is inclined so as to approach the principal surface 42b toward the opening 4a. The first end of the inclined region 42g in the Z-axis direction extends to the principal surface 42b. The first end of the inclined region 42g in the Z-axis direction is positioned inside the opening 4a. The second end of the inclined region 42g in the Z-axis direction is aligned with the first end of the partition wall 422 in the Z-axis direction. A width of the inclined region 42g in the X-axis direction is the same as a width of the recess 421 in the X-axis direction.

The first internal space S1 is a space excluding the second member 42 in the internal space 41c. The opening 4a of the first container 4 is formed by an opening of the internal space 41c and an opening of the recess 421. The first container 4 includes a light-transmissive region 4b. The light-transmissive region 4b is a region of the first member 41 overlapping the first internal space S1 (i.e., recess 421) as viewed in the Y-axis direction. The light-transmissive region 4b is a portion of the first member 41 located on a side opposite to the principal surface 41b with respect to the first internal space S1. Light generated in the first internal space S1 passes through the light-transmissive region 4b. Therefore, the light-transmissive region 4b is light-transmissive to the light generated in the first internal space S1. The light-transmissive region 4b only needs to be able to transmit at least a part of the light generated in the first internal space S1. In the present embodiment, the entire first member 41 and second member 42 are light-transmissive. A material of each of the first member 41 and the second member 42 is, for example, a transparent resin.

An identification surface 41e is formed on the principal surface 41b of the first member 41. The identification surface 41e is parallel to the Z-axis direction and is inclined with respect to the principal surface 41b. The identification surface 41e extends to both ends of the first member 41 in the Z-axis direction. According to the identification surface 41e, the principal surface 41a including the light-transmissive region 4b can be easily identified. The first member 41 is integrally formed of the same material. As a result, leakage of the first solution 6 housed in the internal space 41c is reduced.

The rotor 5 is disposed in the second region 42d. The rotor 5 has, for example, a rod shape. The rotor 5 has, for example, magnetism. The diameter of the rotor 5 is, for example, 1 mm or less. The length of the rotor 5 is, for example, 10 mm or less. The rotor 5 includes, for example, a core material, a plating layer formed on a surface of the core material, and the like. The core material has, for example, magnetism. A material of the plating layer is, for example, gold. The rotor 5 rotates in accordance with the rotation of a rotation device provided outside the first container 4. The rotor 5 rotates about a line parallel to the Y-axis direction in a state of being supported by the support 423.

The first solution 6 is housed in the first internal space S1. The first solution 6 is filled in a part of the first region 42c, the intermediate region 42e, and the second region 42d. A surface 6a of the first solution 6 is positioned between the first end of the partition wall 422 and the opening 4a in the Z-axis direction. That is, the first solution 6 does not extend to the opening 4a. The rotor 5 is immersed in the first solution 6. In other words, the rotor 5 is housed in the first internal space S1 to be immersed in the first solution 6. The rotor 5 is buried in the first solution 6. In FIGS. 4 and 5, the illustration of the first solution 6 is omitted.

The first solution 6 is a mixture of a plurality of reagents. For example, the first solution 6 contains, as the plurality of reagents, at least one of physiological saline and a buffer solution, a fluorescent indicator, and the like. The physiological saline has a function of maintaining the osmotic pressure of cells contained in the biological sample in an isotonic state close to that in a living body. This can suppress destruction or denaturation of cells during measurement. The buffer solution has a function of maintaining the pH of the first solution 6 within a predetermined range. Since the activity of the biological sample may depend on pH, stabilizing the pH with the buffer solution can enhance the reliability and reproducibility of the measurement. The fluorescent indicator reacts with a component (HOCl) generated from the biological sample. The fluorescent indicator is, for example, aminophenyl fluorescein (APF) or the like. A commercially available product may be used as the fluorescent indicator. The fluorescent indicator may react with components generated from the biological sample, such as reactive oxygen species, superoxide, and nitric oxide. The fluorescent indicator may be, for example, DCFH-DA, BES-So, DAF-2, or the like.

The first solution 6 is cooled in a state of being housed in the first internal space S1. In the present embodiment, a case where the first solution 6 is frozen in a state of being housed in the first internal space S1 is illustrated. The first solution 6 may be cooled to an extent that it is not frozen in a state of being housed in the first internal space S1. The first solution 6 may be entirely frozen or partially frozen. Freezing the first solution 6 means that at least a part of the first solution 6 is frozen. A temperature of the first solution 6 is equal to or lower than a freezing point of any reagent contained in the first solution 6. That is, the temperature of the first solution 6 may be the same as the freezing point of any reagent contained in the first solution 6, or may be lower than the freezing point of any reagent contained in the first solution 6. In the present embodiment, the temperature of the first solution 6 is equal to or lower than a freezing point of a reagent having a largest volume among the plurality of reagents contained in the first solution 6. The temperature of the first solution 6 may be equal to or lower than a freezing point of a reagent having a lowest freezing point among the plurality of reagents contained in the first solution 6. In the present embodiment, the temperature of the first solution 6 is equal to or lower than a freezing point of the buffer solution contained in the first solution 6. The temperature of the first solution 6 may be equal to or lower than the freezing point of the fluorescent indicator contained in the first solution 6. In the present embodiment, the entire temperature of the first measurement kit 2 is equal to or lower than the freezing point of any reagent contained in the first solution 6. The temperature of the first solution 6 is, for example, −20° C. In the present embodiment, the “temperature”means a temperature under atmospheric pressure.

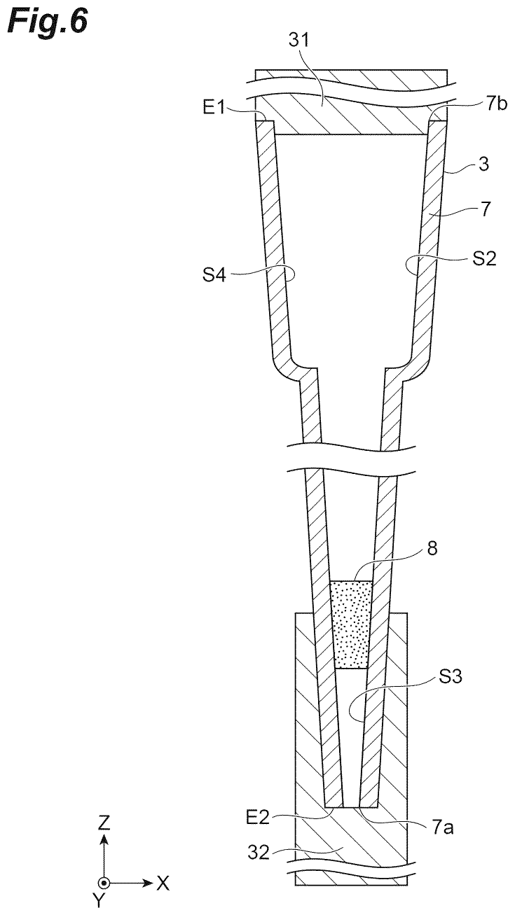

As illustrated in FIG. 6, the second measurement kit 3 includes a second container 7, a second solution 8, a first sealing member 31, and a second sealing member 32. The second container 7 has, for example, a conical shape whose center line is a line parallel to the Z-axis direction. The second container 7 has, for example, elasticity. As illustrated in FIG. 6, the second container 7 includes a second internal space S2, an opening 7a (a second opening), and an opening 7b (a first opening). The opening 7a and the opening 7b are formed at different positions in the second container 7. Specifically, the opening 7a and the opening 7b are formed at opposite ends of the second container 7. For example, the opening 7b is formed at the first end E1 of the second container 7 in the Z-axis direction. The opening 7a is formed at the second end E2 of the second container 7 in the Z-axis direction. Each of the opening 7a and the opening 7b opens into the second internal space S2. The second internal space S2 has, for example, a conical shape. A cross-sectional area of the second internal space S2 decreases from the opening 7b toward the opening 7a. A diameter of the opening 7a is smaller than a diameter of the opening 7b. The opening 7a is a discharge port of the second container 7. The opening 7a may function as a suction port of the second container 7. The second container 7 is, for example, a pipette tip.

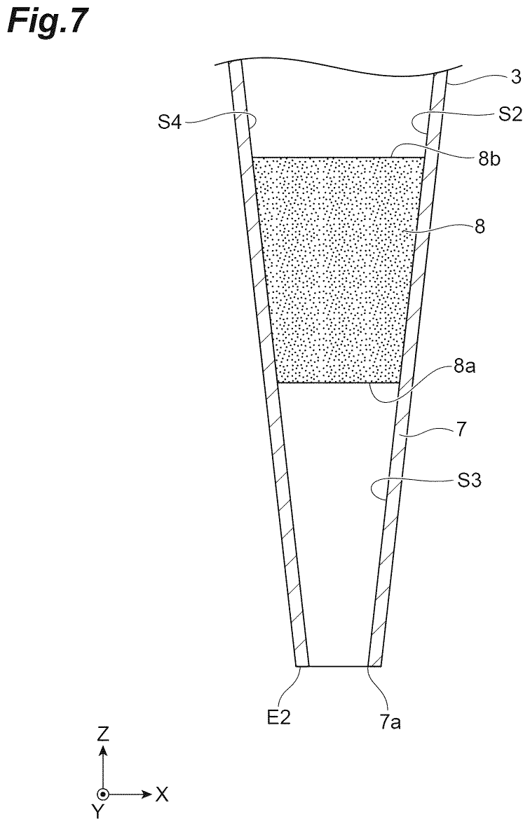

The second solution 8 is housed in the second internal space S2. The second solution 8 fills a part of the second internal space S2. A temporary space S3 is present between the second solution 8 and the opening 7a, and a space S4 is present between the second solution 8 and the opening 7b. Specifically, the second solution 8 is positioned inside each of the opening 7a and the opening 7b. As illustrated in FIG. 7, the second solution 8 includes a surface 8a facing the opening 7a and a surface 8b facing the opening 7b. The surface 8a is spaced apart from the opening 7a. The surface 8b is spaced apart from the opening 7b.

A volume of the temporary space S3 is equal to or larger than a volume of the second solution 8. A length of the temporary space S3 in the Z-axis direction (i.e., a distance between the opening 7a and the surface 8a) is equal to or longer than a length of the second solution 8 in the Z-axis direction (i.e., a distance between the surface 8a and the surface 8b). A volume of the space S4 is equal to or larger than the volume of the second solution 8. A length of the space S4 in the Z-axis direction (i.e., a distance between the opening 7b and the surface 8b) is equal to or longer than the length of the second solution 8 in the Z-axis direction. The volume of the space S4 may be smaller than the volume of the second solution 8. The length of the space S4 in the Z-axis direction may be smaller than the length of the second solution 8 in the Z-axis direction. The volume of the space S4 is equal to or larger than the volume of the temporary space S3. The length of the space S4 in the Z-axis direction is equal to or longer than the length of the temporary space S3 in the Z-axis direction. The volume of the space S4 may be smaller than the volume of the temporary space S3. The length of the space S4 in the Z-axis direction may be smaller than the length of the temporary space S3 in the Z-axis direction.

The second solution 8 is a mixture of a plurality of reagents. The second solution 8 contains, for example, a stimulant and an organic solvent as the plurality of reagents. The stimulant is a reagent for activating a function of the biological sample. The stimulant stimulates, for example, mimics stimulation of the neutrophils of the biological sample. When the neutrophils are mimically stimulated, an innate immune response (biological defense mechanism) of the neutrophils is triggered. The stimulant is, for example, N-formyl-L-methionyl-L-leucyl-phenylalanine (fMLP), 4β-phorbol-12-myristate-13-acetate (PMA), or the like. The organic solvent is a reagent for dissolving a stimulant in a powder state or diluting the stimulant in a liquid state. The organic solvent is, for example, dimethyl sulfoxide (DMSO).

The second solution 8 is frozen in a state of being housed in the second internal space S2. The second solution 8 is frozen in a state where the temporary space S3 is present between the second solution 8 and the opening 7a and the space S4 is present between the second solution 8 and the opening 7b. The second solution 8 may be entirely frozen or partially frozen. Freezing the second solution 8 means that at least a part of the second solution 8 is frozen.

A temperature of the second solution 8 is equal to or lower than a freezing point of any reagent contained in the second solution 8. That is, the temperature of the second solution 8 may be the same as the freezing point of any reagent contained in the second solution 8, or may be lower than the freezing point of any reagent contained in the second solution 8. In the present embodiment, the temperature of the second solution 8 is equal to or lower than a freezing point of a reagent having a largest volume among the plurality of reagents contained in the second solution 8. The temperature of the second solution 8 may be equal to or lower than a freezing point of a reagent having a lowest freezing point among the plurality of reagents contained in the second solution 8.

In the present embodiment, the temperature of the second solution 8 is equal to or lower than a freezing point of the organic solvent contained in the second solution 8. In the present embodiment, the entire temperature of the second measurement kit 3 is equal to or lower than the freezing point of any reagent contained in the second solution 8. The temperature of the second solution 8 is, for example, the same as the temperature of the first solution 6. That is, the temperature of the second solution 8 is, for example, −20° C. The temperature of the second solution 8 may be lower than the temperature of the first solution 6. The temperature of the second solution 8 may be, for example, −30° C. or lower, −40° C. or lower, or −80° C. or lower.

In the present embodiment, the second solution 8 does not contain a buffer solution. Therefore, the deterioration of the stimulant caused by the buffer solution is suppressed. Specifically, the stimulant diluted with the buffer solution tends to deteriorate as the period until the freezing of the second solution 8 becomes longer. In a case where the second solution 8 does not contain the buffer solution, even though the period until freezing of the second solution 8 is relatively long, the deterioration of the stimulant is suppressed.

The second solution 8 may further contain a buffer solution. The buffer solution is a reagent for diluting an organic solvent. Since the organic solvent is diluted with the buffer solution in the second solution 8, even though the second solution 8 is directly applied to the biological sample, damage to the biological sample by the organic solvent is suppressed. A commercially available product may be used as each of the stimulant, the organic solvent, and the buffer solution, for example. When the organic solvent is diluted with the buffer solution, the stimulant dissolved in the organic solvent may easily deteriorate. In contrast, by lowering the temperature of the second solution 8 to be lower than that of the first solution 6 as described above (i.e., to an ultra-low temperature), even if the organic solvent is diluted with the buffer solution for direct application to the biological sample, it is possible to store the second solution 8 while maintaining a state in which deterioration of the stimulant dissolved in the organic solvent is suppressed.

As illustrated in FIG. 6, the first sealing member 31 is disposed so as to close the opening 7b of the second container 7. The first sealing member 31 fills the opening 7b of the second container 7 without any gap. The first sealing member 31 may be in contact with the first end E1 of the second container 7 or may not be in contact with the first end E1 of the second container 7. That is, the first sealing member 31 does not need to be in contact with the first end E1 of the second container 7. The first sealing member 31 is detachably attached to the second container 7. The first sealing member 31 is, for example, a cap, a silicone cord, or a filter attached to a pipette tip.

The second sealing member 32 is disposed so as to close the opening 7a of the second container 7 located on the side opposite to the opening 7b. The second sealing member 32 may be in contact with the second end E2 of the second container 7 or may not be in contact with the second end E2 of the second container 7. That is, the second sealing member 32 does not need to be in contact with the second end E2 of the second container 7. A space may be formed between the second sealing member 32 and the second end E2 of the second container 7. The second sealing member 32 may fill the opening 7a of the second container 7 without any gap. The second sealing member 32 is detachably attached to the second container 7. The second sealing member 32 is, for example, a cap, a silicone cord, or a filter attached to a pipette tip.

The first sealing member 31 and the second sealing member 32 close the opening 7a and the opening 7b of the second container 7, respectively, so that the second internal space S2 of the second container 7 is sealed. Sealing the second internal space S2 means that the opening 7b and the opening 7a of the second container 7 are closed without a gap by the first sealing member 31 and the second sealing member 32 so that air from outside the second container 7 does not enter the second internal space S2. When the second measurement kit 3 is housed in the internal space V of the sealing bag 100 illustrated in FIG. 1, the second measurement kit 3, in a state where the frozen second solution 8 is housed in the second internal space S2 and the openings 7b and 7a are closed by the first sealing member 31 and the second sealing member 32, is housed in the internal space V.

As described above, the second solution 8 is housed in the second container 7 in a frozen state. In this case, the measurement unit 1 can be carried in the vicinity of a subject in a state where the second solution 8 is frozen. After thawing the second solution 8 in the vicinity of the subject, the thawed second solution 8 can be added to the first solution 6 to which the biological sample is to be added. Thus, not only is the quality of the second solution 8 housed in the second container 7 maintained, but an operation such as introduction of the second solution 8 into the second container 7 also becomes unnecessary in the vicinity of the subject.

However, the temperature of the frozen second solution 8 greatly affects the quality of the second solution 8. For example, when the temperature of the second solution 8 is maintained at −80° C., the quality of the second solution 8 in a frozen state can be maintained for about 3 months or more. When the temperature of the second solution 8 is maintained at −30° C., the quality of the second solution 8 in a frozen state can be maintained for about 1 month. On the other hand, when the temperature of the second solution 8 is maintained at −20° C., the quality of the second solution 8 in a frozen state can be maintained only for about 5 days. Therefore, from the viewpoint of maintaining the quality of the second solution 8 for a long period of time, it is conceivable to maintain the temperature of the second solution 8 at an ultra-low temperature such as −80° C. or less.

However, when the temperature of the second solution 8 is maintained at an ultra-low temperature such as −30° C. or lower, a special freezer is required. In this case, the transportation cost required for maintaining the temperature of the second solution 8 increases, and the user needs to prepare a special refrigerator, which causes a problem of deterioration in usability. In a case where the temperature of the second solution 8 is maintained at −20° C. or higher, a special freezer is unnecessary, so that reduction in transportation cost and improvement in usability can be expected. However, as described above, there remains a problem that the quality of the second solution 8 cannot be maintained over a long period of time.

In view of this problem, the present inventors have extensively conducted studies on factors that deteriorate the quality of the second solution 8 when the temperature of the second solution 8 is maintained at about −20° C., and as a result found that moisture absorbed by the second solution 8 may have a large influence on the quality of the second solution 8. DMSO as an organic solvent contained in the second solution 8 has high hygroscopicity. That is, DMSO has a property of easily absorbing moisture contained in ambient air. Since PMA, which is the stimulant contained in the second solution 8, loses its activity due to hydrolysis, when PMA is dissolved in DMSO, PMA may lose its activity due to hydrolysis with the water absorbed by DMSO, and the quality of the second solution 8 may deteriorate. Since the melting point of DMSO is 19° C., when the second solution 8 is maintained at −20° C., the second solution 8 is in a solid state, but the hydrolysis described above may slightly proceed in the second solution 8.

Therefore, in the present embodiment, the second container 7 is housed in the sealing bag 100 in order to prevent absorption of moisture into the second solution 8. When the second container 7 is housed in the internal space V of the sealed sealing bag 100, it is possible to prevent air outside the sealing bag 100 from coming into contact with the second solution 8 inside the second container 7, that is, moisture in the air from being absorbed by the second solution 8. This makes it possible to suppress deterioration in the quality of the second solution 8 due to the progress of hydrolysis.

As in the present embodiment, the measurement unit 1 may include a first sealing member 31 that closes the opening 7b of the second container 7 and a second sealing member 32 that closes the opening 7a of the second container 7. In this case, the interior of the second container 7 can be sealed by the first sealing member 31 and the second sealing member 32. This can effectively prevent moisture in the air around the second container 7 from being absorbed by the second solution 8 inside the second container 7. Depending on the temperature of the second solution 8, the first sealing member 31 may come off from the opening 7b of the second container 7. Therefore, the measurement unit 1 may not include the first sealing member 31 that closes the opening 7b of the second container 7. That is, in a state where the second container 7 is housed in the internal space V of the sealing bag 100, the opening 7b of the second container 7 may be open without being closed by the first sealing member 31.

As in the present embodiment, the measurement unit 1 may include the moisture absorbent 10 that is housed in the internal space V of the sealing bag 100 together with the second container 7 and absorbs moisture in the air. In this case, since the moisture in the air can be absorbed by the moisture absorbent 10, it is possible to effectively prevent the moisture from being absorbed by the second solution 8 inside the second container 7.

As in the present embodiment, one second container 7 may be housed in the internal space V of the sealing bag 100. In this case, the measurement unit 1 can be realized with a simple configuration.

As in the present embodiment, the sealing bag 100 may house the first container 4 and the second container 7 in the internal space V. In this case, since the first solution 6 is housed in the first container 4 in a frozen state, the measurement unit 1 can be carried to the vicinity of the subject in a state where the first solution 6 is frozen. After thawing the first solution 6 in the vicinity of the subject, the biological sample collected from the subject can be added to the first solution 6. Thus, not only is the quality of the first solution 6 maintained, but operations such as preparation of the first solution 6 and introduction of the first solution 6 into the first container 4 also become unnecessary in the vicinity of the subject. Therefore, according to the present embodiment, the qualities of the first solution 6 and the second solution 8 are maintained, and the operation for measuring the characteristic of the biological sample is simplified. Furthermore, in the present embodiment, since the first container 4 and the second container 7 can be transported together using one sealing bag 100, it is possible to reduce the transportation cost of the measurement unit 1 and improve the usability as compared with the case where the first container 4 and the second container 7 are housed in different sealing bags and transported.

As in the present embodiment, the biological sample may contain white blood cells. The first solution 6 used for measuring the characteristic of the white blood cell may require cryopreservation. As described above, since the first solution 6 is frozen, the cryopreservation of the first solution 6 is realized.

As in the present embodiment, the indicator may be a fluorescent indicator. The first solution 6 containing the fluorescent indicator may require cryopreservation. As described above, since the first solution 6 containing the fluorescent indicator is frozen, the cryopreservation of the first solution 6 containing the fluorescent indicator is realized.

As in the present embodiment, the organic solvent may be DMSO. As described above, DMSO has high hygroscopicity. Therefore, it is assumed that when the stimulant contained in the second solution 8 is dissolved by the DMSO, hydrolysis of the stimulant may proceed. In contrast, in the measurement unit 1 of the present embodiment, as described above, moisture in the air around the second container 7 can be prevented from being absorbed by the second solution 8. This makes it possible to suppress deterioration in the quality of the second solution 8 due to the progress of hydrolysis, so that the above-described effect can be exhibited.

The sealing bag 100, the moisture absorbent 10, the first sealing member 31, and the second sealing member 32 described above function as a moisture-proof portion that prevents contact between moisture contained in the air outside the second container 7 and the second solution 8 inside the second container 7. When the measurement unit 1 has such a moisture-proof portion, the moisture absorption rate of the second solution 8 can be reduced. The moisture absorption rate can be defined by, for example, the ratio between the mass of the second solution 8 after the frozen second solution 8 is placed in the second container 7 for a certain period of time and the mass of the second solution 8 before the frozen second solution 8 is placed in the second container 7 for a certain period of time.

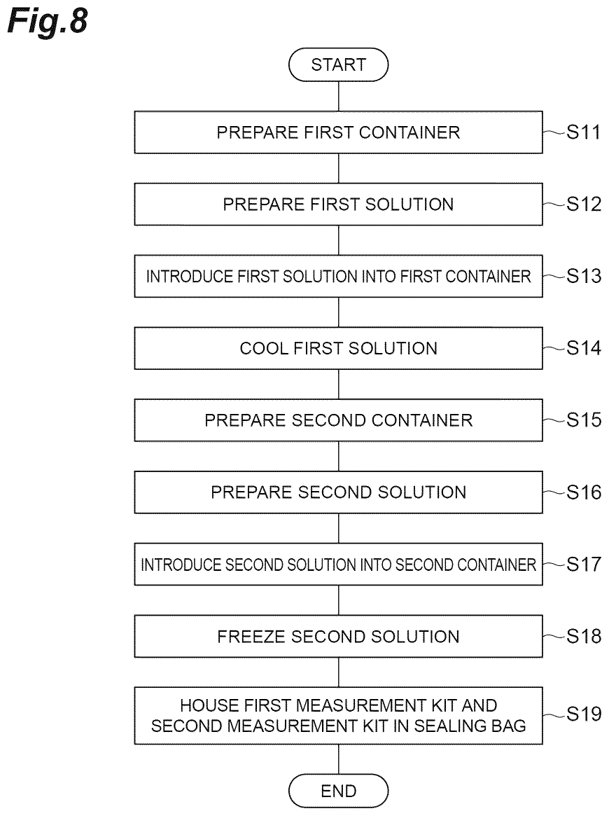

Next, a method for manufacturing the measurement unit 1 will be described. The manufacturing process of the measurement unit 1 includes, for example, steps S11 to S19 illustrated in FIG. 8. Among these steps, in at least one step excluding step S16 (preparation of the second solution 8) and step S17 (introduction of the second solution 8 into the second container 7) in which the second solution 8 needs to be in a liquid state, the temperature of the second solution 8 is maintained at or below the freezing point (19° C.) of DMSO as an organic solvent.

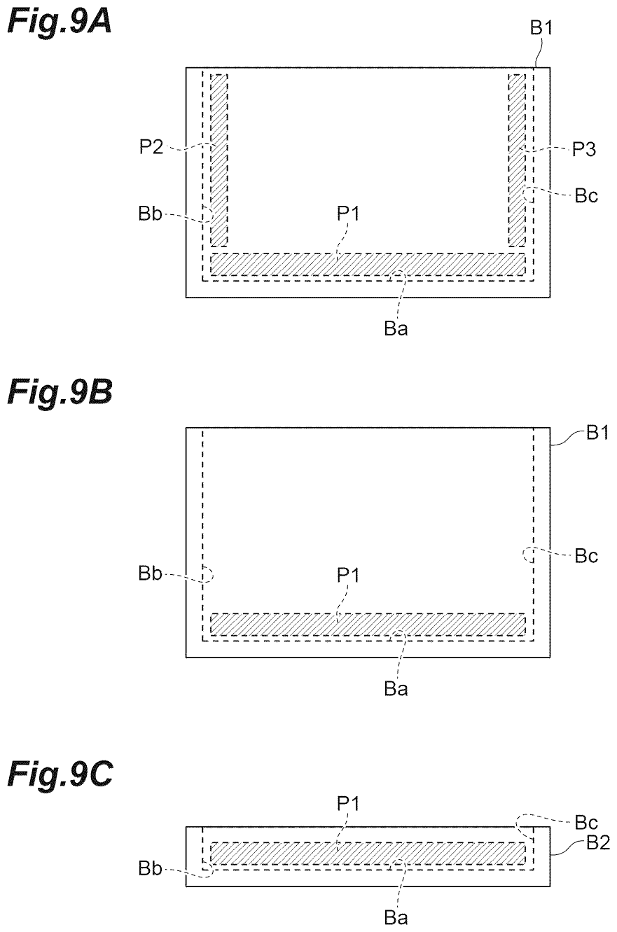

In order to maintain the temperature of the second solution 8 at or below the freezing point of DMSO, for example, a cold storage box B1 illustrated in FIG. 9A is used. The cold storage box B1 is, for example, a rectangular box-shaped container. Three cold packs P1, P2, and P3 are disposed inside the cold storage box B1. The cold pack P1 is disposed on the bottom surface Ba inside the cold storage box B1. The cold packs P2 and P3 are respectively disposed on two side surfaces Bb and Bc rising from the bottom surface Ba inside the cold storage box B1. By performing at least one step included in the manufacturing process of the measurement unit 1 in a state where the cold packs P1, P2, and P3 are disposed inside the cold storage box B1 in this manner, the temperature of the second solution 8 can be maintained at the freezing point (19° C.) of DMSO or less.

As illustrated in FIG. 9B, only the cold pack P1 may be disposed inside the cold storage box B1. As illustrated in FIG. 9C, a cold storage box B2 having a height lower than that of the cold storage box B1 may be used. Only the cold pack P1 may be disposed inside the cold storage box B2. The present inventors confirmed the transition of the temperature of the buffer in a state where 750 μl of the cryopreserved buffer was placed inside the cold storage boxes B1 and B2. As a result, it was found that the increase in the temperature of the buffer can be most suppressed when the cold storage box B1 of FIG. 9A is used. Specifically, the temperature of the cryopreserved buffer shifted from 5.7° C. to 6.5° C. after 3 minutes, shifted to 7.1° C. after 15 minutes, and shifted to 7.0° C. after 30 minutes. When the cold storage box B1 in FIG. 9B was used, the temperature of the buffer shifted from 6.0° C. to 12.5° C. after 3 minutes, 17.8° C. after 15 minutes, and 18.8° C. after 30 minutes. When the cold storage box B2 in FIG. 9C was used, the temperature of the buffer shifted from 6.6° C. to 16.7° C. after 3 minutes, 21.8° C. after 15 minutes, and 18.8° C. after 30 minutes.

As illustrated in FIG. 8, when the measurement unit 1 is manufactured, first, in step S11, the first container 4 is prepared. In step S11, the first container 4 is prepared in a state where the rotor 5 is housed in the first internal space S1.

In step S12, the first solution 6 is prepared. In step S12, the plurality of reagents (e.g., at least one of physiological saline and a buffer solution, and fluorescent indicator) are mixed outside the first internal space S1. The volume of the first solution 6 prepared in step S12 is several times or more the volume of the first internal space S1. That is, in step S12, a larger amount of the first solution 6 than the volume of the first internal space S1 is prepared. In step S13, the first solution 6 prepared in advance is introduced into the first internal space S1. In step S13, the first solution 6 is sequentially introduced into the first housing spaces S1 of the plurality of first containers 4.

In step S14, the first solution 6 is cooled in a state of being housed in the first internal space S1. In the present embodiment, the first solution 6 is frozen in a state of being housed in the first internal space S1. In step S14, the first solution 6 is frozen in a state where the rotor 5 housed in the first internal space S1 is immersed in the first solution 6. In step S14, the first measurement kit 2 in which the rotor 5 and the first solution 6 are housed in the first container 4 is disposed in a cooling space of a cooling facility. The temperature of the cooling space is, for example, −20° C. The first measurement kit 2 is disposed in the cooling space for about 2 hours, for example. As a result, the first measurement kit 2 in which the first solution 6 has been frozen is manufactured. The first measurement kit 2 may be housed in the cooling space. In step S14, the opening 4a of the first container 4 may be sealed with a sealing member such as parafilm or a rubber stopper.

In step S15, the second container 7 is prepared. In step S16, the second solution 8 is prepared. In step S16, the plurality of reagents (e.g., a stimulant and an organic solvent) are mixed outside the second internal space S2. The volume of the second solution 8 prepared in step S16 is several times or more the volume of the second internal space S2. That is, in step S16, a larger amount of the second solution 8 than the volume of the second internal space S2 is prepared.

In step S17, the second solution 8 prepared in advance is introduced into the second internal space S2. In step S17, after the second solution 8 is drawn into the second internal space S2 via the opening 7a, air is further drawn into the second internal space S2 via the opening 7a.

Specifically, in step S17, a prescribed amount of the second solution 8 is placed in a preparatory container such as a microtube or a microplate. Subsequently, a suction nozzle is inserted into the opening 7b of the second container 7. Subsequently, the second container 7 is disposed such that the opening 7a of the second container 7 comes into contact with the second solution 8. Subsequently, the prescribed amount of the second solution 8 is drawn into the second internal space S2 via the opening 7a by a suction force of the suction nozzle. Subsequently, air is drawn into the second internal space S2 via the opening 7a. As a result, the temporary space S3 is formed between the opening 7a and the second solution 8. A volume of the air drawn in step S17 is equal to or larger than a volume of the second solution 8 drawn in step S17. In step S17, for example, the second solution 8 disposed in one preparatory container or the like may be simultaneously introduced into the second housing spaces S2 of the plurality of second containers 7.

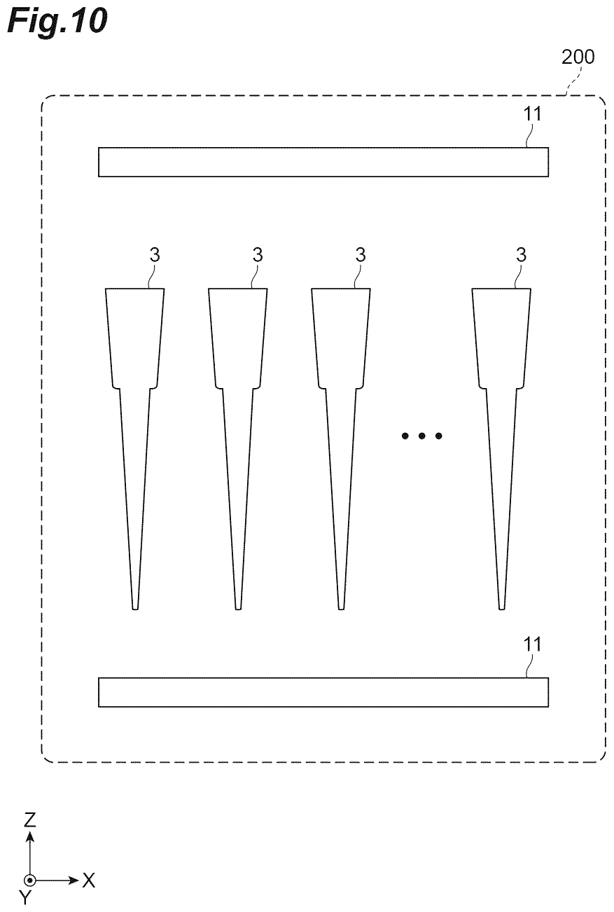

In step S18, the second solution 8 is frozen in a state of being housed in the second internal space S2. In step S18, the suction nozzle is withdrawn from the opening 7b of the second container 7. Subsequently, the second container 7 is disposed in the cooling space of the cooling facility in a state where the temporary space S3 is present between the opening 7a and the second solution 8 and the space S4 is present between the opening 7b and the second solution 8. In the present embodiment, the second measurement kit 3, in which the opening 7b and the opening 7a of the second container 7 are closed by the first sealing member 31 and the second sealing member 32 as illustrated in FIG. 6, is placed in the cooling space of a cooling facility while being housed in a cooling container 200 together with other second measurement kits 3, as illustrated in FIG. 10. The cooling container 200 is, for example, a chip rack. Two moisture absorbents 11 are respectively housed in a bottom surface and an upper surface of the cooling container 200.

The moisture absorbent 11 is, for example, the same agent as the moisture absorbent 10. Therefore, similarly to the moisture absorbent 10, the moisture absorbent 11 has hygroscopicity to absorb moisture in the surrounding air. The moisture absorbent 11 absorbs moisture in the air present around the second measurement kit 3 inside the cooling container 200. Therefore, the contact of moisture in the air around the second measurement kit 3 with the second solution 8 of the second measurement kit 3 is reduced. The moisture absorbent 11 is, for example, a desiccant formed of zeolite or the like. The moisture absorbent 11 may be a dehumidifying agent or a water absorbent. The form of the moisture absorbent 11 may be any of a sheet, granules, a mass, fibers, and a sphere.

The second measurement kit 3 is disposed in the cooling space of the cooling facility, for example, for about 1 hour. The temperature of the cooling space is, for example, −80° C. As a result, the second measurement kit 3, in which the second solution 8 is frozen, is manufactured. The second measurement kit 3 may be housed in the cooling space.

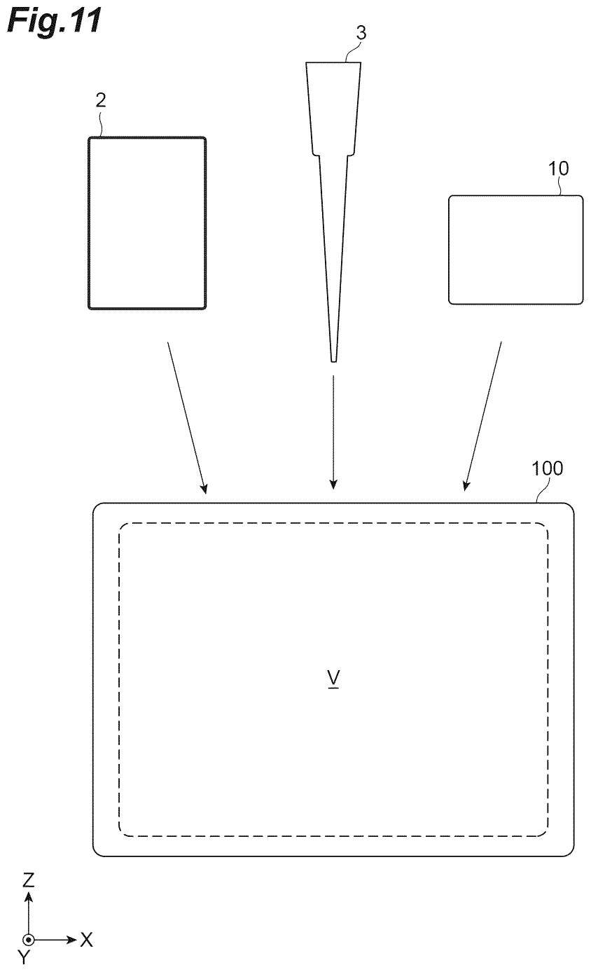

In step S19, as illustrated in FIG. 11, the first measurement kit 2

and the second measurement kit 3 are housed in the internal space V of the sealing bag 100 together with the moisture absorbent 10. The atmosphere of the internal space V of the sealing bag 100 may be replaced with a nitrogen atmosphere. Specifically, the atmosphere in the internal space V may be replaced with a nitrogen atmosphere by repeatedly evacuating the internal space V and introducing nitrogen (N₂). The internal space V of the sealing bag 100 may be maintained under vacuum. Thereafter, the internal space V is sealed in a state where the first measurement kit 2, the second measurement kit 3, and the moisture absorbent 10 are housed in the internal space V of the sealing bag 100. As a result, the measurement unit 1 in which one first measurement kit 2, one second measurement kit 3, and one moisture absorbent 10 are housed in the sealed internal space V is manufactured. The first measurement kit 2 and the second measurement kit 3 may be stored in the cooling space in a state of being housed in the internal space V of the sealing bag 100.

In the sealed internal space V, the first solution 6 of the first measurement kit 2 and the second solution 8 of the second measurement kit 3 are in a frozen state. In this state, the opening 7b and the opening 7a of the second container 7 of the second measurement kit 3 are closed by the first sealing member 31 and the second sealing member 32, respectively. When the first solution 6 of the first measurement kit 2 is frozen, frost may adhere to the first container 4. In this case, the first measurement kit 2 and the second measurement kit 3 may be housed in separate spaces partitioned from each other inside the sealing bag 100. That is, inside the sealing bag 100, a space for housing the first container 4 and a space for housing the second container 7 may be partitioned from each other. For example, the sealing bag 100 may be partitioned in advance by a sealer or the like. The second measurement kit 3 may be housed in a sealing bag having a size smaller than that of the sealing bag 100. In this case, the moisture absorbent 10 may be housed in the same space as the second measurement kit 3. The moisture absorbent 10 may not be provided inside the sealing bag 100.

At least one of steps S15 to S18 may be performed simultaneously with at least one of steps S11 to S14. The order of steps S11 to S19 is not limited to the example illustrated in FIG. 8, and may be optionally changed. For example, step S14 (freezing of the first solution 6) and step S18 (freezing of the second solution 8) may be performed after step S19 (accommodation of the first measurement kit 2 and the second measurement kit 3 in the sealing bag 100). That is, the first solution 6 and the second solution 8 may be frozen after the first measurement kit 2 containing the unfrozen first solution 6 and the second measurement kit 3 containing the unfrozen second solution 8 are housed in the internal space V of the sealing bag 100 together with the moisture absorbent 10. In step S14, the first solution 6 may be cooled to an extent that it is not frozen in a state of being housed in the first internal space S1.

According to the manufacturing method, it is possible to manufacture the measurement unit 1 having the above-described effect.

As in the present embodiment, in step S18, the second solution 8 may be frozen in a state where the opening 7b of the second container 7 is closed by the first sealing member 31 and the opening 7a of the second container 7 is closed by the second sealing member 32. In this case, the second solution 8 inside the second container 7 can be frozen in a state where the inside of the second container 7 is sealed by the first sealing member 31 and the second sealing member 32. This can effectively prevent moisture in the air around the second container 7 from being absorbed by the second solution 8 inside the second container 7.

As in the present embodiment, in step S19, the internal space V may be sealed in a state where the moisture absorbent 10 that absorbs moisture in the air is housed in the internal space V together with the second container 7. In this case, in step S19, since the moisture in the air can be absorbed by the moisture absorbent 10, it is possible to effectively prevent the moisture from being absorbed by the second solution 8 inside the second container 7.

As in the present embodiment, in step S19, the internal space V may be sealed in a state where the first container 4 and the second container 7 are housed in the internal space V. In this case, as described above, since the first solution 6 is housed in the first container 4 in a frozen state, the measurement unit 1 can be carried to the vicinity of the subject in a state where the first solution 6 is frozen. After thawing the first solution 6 in the vicinity of the subject, the biological sample collected from the subject can be added to the first solution 6. Thus, not only is the quality of the first solution 6 maintained, but operations such as preparation of the first solution 6 and introduction of the first solution 6 into the first container 4 also become unnecessary in the vicinity of the subject. Therefore, according to the present embodiment, the qualities of the first solution 6 and the second solution 8 are maintained, and the operation for measuring the characteristic of the biological sample is simplified. Furthermore, in the present embodiment, since the first container 4 and the second container 7 can be transported together using one sealing bag 100, it is possible to reduce the transportation cost of the measurement unit 1 and improve the usability as compared with the case where the first container 4 and the second container 7 are housed in different sealing bags and transported.

As in the present embodiment, in steps other than steps S16 and S17, the temperature around the second container 7 may be maintained at or below the freezing point of the organic solvent (DMSO). In this case, the temperature around the second container 7 is maintained at temperature equal to or lower than the freezing point of the organic solvent, whereby the progress of hydrolysis of the stimulant due to moisture absorption by the organic solvent can be suppressed. This makes it possible to suppress deterioration in the quality of the second solution 8 due to the progress of hydrolysis.

As in the present embodiment, in step S18, the second solution 8 may be frozen in a state where the moisture absorbent 11 that absorbs moisture in the air is disposed around the second container 7. In this case, in step S18, since the moisture in the air can be absorbed by the moisture absorbent 11, it is possible to effectively prevent the moisture from being absorbed by the second solution 8 inside the second container 7.

As in the present embodiment, in step S19, the internal space V of the sealing bag 100 may be sealed in a state where the atmosphere of the internal space V is replaced with the nitrogen atmosphere. In this case, since the humidity of the internal space V of the sealing bag 100 can be reduced, absorption of the moisture in the internal space V by the second solution 8 inside the second container 7 can be effectively reduced.

As in the present embodiment, in step S19, the internal space V of the sealing bag 100 may be sealed in a state where the internal space V is maintained under vacuum. In this case, since the humidity of the internal space V of the sealing bag 100 can be reduced, absorption of the moisture in the internal space V by the second solution 8 inside the second container 7 can be effectively reduced.

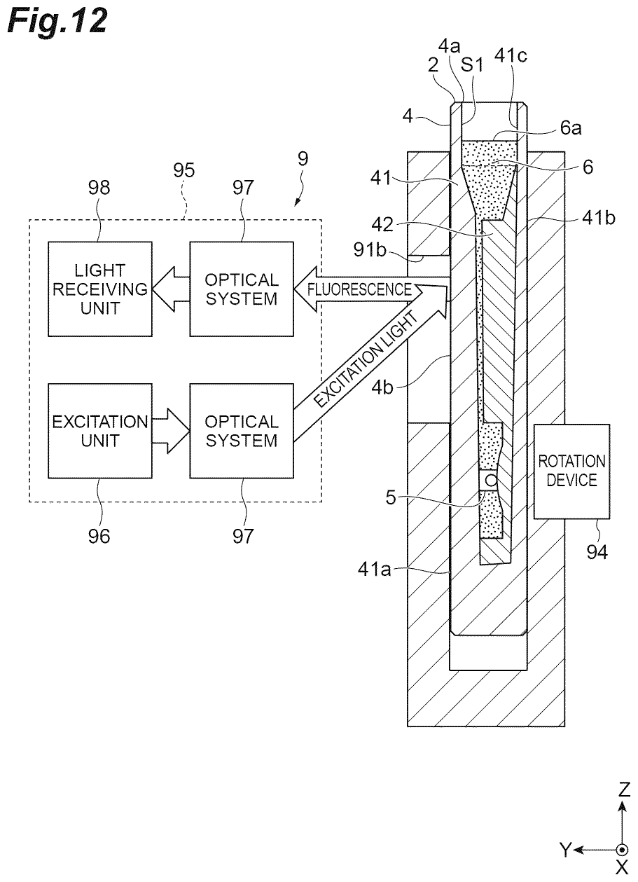

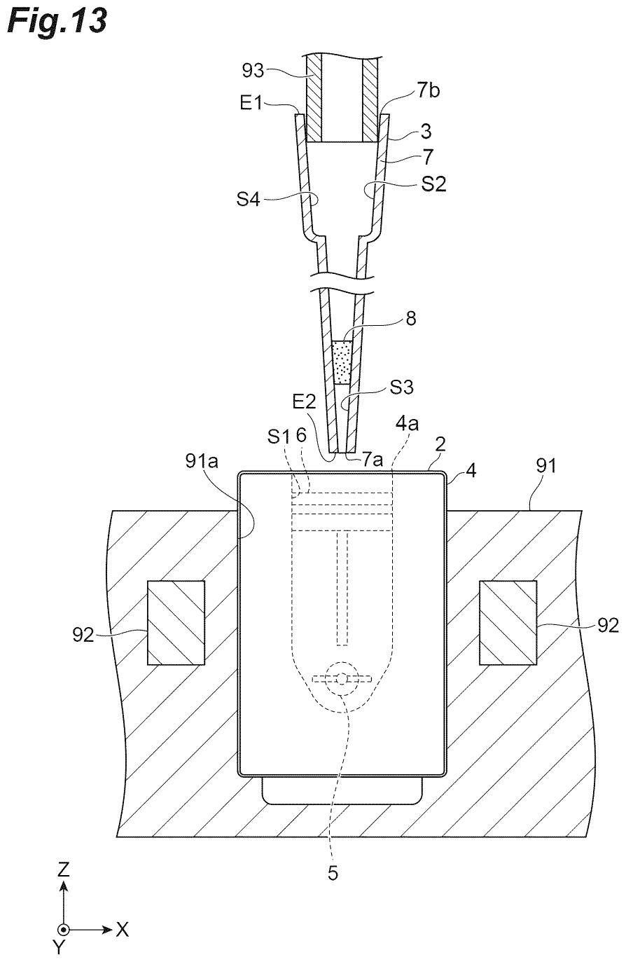

Next, a biological sample measurement method using the measurement unit 1 will be described. First, a measurement device will be described. As illustrated in FIGS. 12 and 13, the measurement device 9 includes a support member 91, heaters 92, a nozzle 93, a rotation device 94, and an optical device 95. The support member 91 includes an attachment space (slot) 91a and an opening 91b. The opening 91b penetrates a side wall of the support member 91. The opening 91b communicates with the attachment space 91a. The first measurement kit 2 is attached to the attachment space 91a such that the light-transmissive region 4b faces the opening 91b. The heaters 92 are provided on the side wall of the support member 91. The heaters 92 are provided on both sides in the X-axis direction with respect to the attachment space 91a as viewed in the Y-axis direction. The heat generated from the heater 92 is transferred to the first measurement kit 2 via the support member 91. The position where the heater 92 is installed is not limited to the above-described example. For example, the heater 92 may be disposed on a measurement surface of the measurement unit 1 or on a side opposite to the measurement surface. The heater 92 may be disposed on both the measurement surface of the measurement unit 1 and the side opposite to the measurement surface.

The nozzle 93 is disposed above the support member 91 in a vertical direction. The nozzle 93 discharges, for example, air. The opening 7b of the second container 7 is attached to the nozzle 93. When air is discharged from the nozzle 93, a pressure in the space S4 becomes larger than a pressure in the temporary space S3. The thawed second solution 8 is led out from the opening 7a by a pressure difference between the space S4 and the temporary space S3. The second solution 8 led out from the opening 7a is added to the first internal space S1 of the first container 4.

The rotation device 94 is disposed on a side opposite to the opening 91b with respect to the attachment space 91a. The rotation device 94 is, for example, a magnetic stirrer. The rotation device 94 rotates the rotor 5 of the first measurement kit 2.

The optical device 95 is disposed on a side opposite to the attachment space 91a with respect to the rotation device 94. The optical device 95 includes an excitation unit 96, optical system 97, and a light receiving unit 98. The excitation unit 96 includes, for example, a light emitting element such as a laser diode or a light emitting diode. The excitation unit 96 emits excitation light. The optical system 97 is disposed between the excitation unit 96 and the attachment space 91a and between the light receiving unit 98 and the attachment space 91a. The optical system 97 is, for example, a lens that collects light. The light receiving unit 98 includes, for example, a photoelectric conversion element such as a photodiode. The light receiving unit 98 detects incident light. The excitation light emitted from the excitation unit 96 reaches the first internal space S1 via the optical system 97, the opening 91b, and the light-transmissive region 4b. As a result, a substance generated by a reaction between a component generated from the biological sample and the fluorescent indicator of the first solution 6 is excited, and as a result, fluorescence is generated. The fluorescence reaches the light receiving unit 98 via the light-transmissive region 4b, the opening 91b, and the optical system 97. The light receiving unit 98 detects the fluorescence.

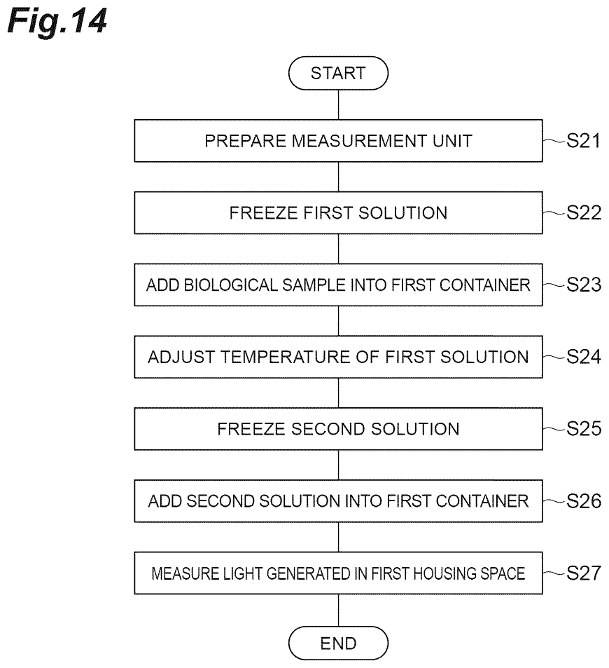

As illustrated in FIG. 14, in the biological sample measurement method, first, in step S21, the measurement unit 1 is prepared.

In step S22, the first solution 6 is thawed. In step S22, the first measurement kit 2 is attached to the attachment space 91a. In step S22, the first solution 6 is heated by the heater 92 until the first solution 6 is thawed. The heat of the heater 92 is transferred to the first solution 6 via the support member 91 and the first container 4. In step S22, the first solution 6 is continuously heated such that the temperature of the first solution 6 reaches an appropriate temperature (optimum temperature) for the biological sample. The appropriate temperature for the biological sample is, for example, 37° C. In step S22, the first solution 6 is heated such that the temperature of the first solution 6 is, for example, 36.5° C. to 37.5° C. In step S22, the first solution 6 is heated for, for example, 5 minutes to 10 minutes. As a result, since the first solution 6 is heated relatively gently, deterioration in function of the first solution 6 is suppressed.

In step S22, the first solution 6 is heated while the rotor 5 is rotated. Specifically, in step S22, the rotor 5 is rotated after the first solution 6 becomes flowable as a result of being thawed. When the rotor 5 rotates, the first solution 6 sequentially flows through the first region 42c, one side of the intermediate region 42e, the second region 42d, and the other side of the intermediate region 42e, and flows from the other side of the intermediate region 42e to one side of the intermediate region 42e through a region between the partition wall 422 and an inner surface of the first member 41. As a result, the heat transfer in the first solution 6 is promoted, and the thawing efficiency of the first solution 6 is improved. In step S22, the rotation device 94 may be started before the first solution 6 becomes flowable (e.g., before the first measurement kit 2 is attached to the attachment space 91a). In this case, the rotor 5 rotates at the same time as the first solution 6 becomes flowable.

In step S23, the biological sample is added to the first internal space S1 via the opening 4a. In step S23, a small amount (about 2 μL to 3 μL) of a peripheral blood collected from a finger of the subject by a blood collection tool such as a lancet is added as the biological sample to the first internal space S1.

In step S24, the temperature of the first solution 6 is adjusted. In step S24, the first solution 6 is heated by the heater 92. In step S24, the first solution 6 is heated such that the temperature of the first solution 6 is maintained at the appropriate temperature for the biological sample. In step S24, the first solution 6 is heated such that the temperature of the first solution 6 is, for example, 36.8° C. to 37.2° C. In step S24, the first solution 6 is heated while the rotor 5 is rotated. Step S24 continues to be performed until the biological sample measurement method is completed.

In step S25, the second solution 8 is thawed. In step S25, the second measurement kit 3 is left for 1 to 2 minutes in a state where the second container 7 of the second measurement kit 3 is attached to the nozzle 93. That is, in step S25, the second solution 8 is naturally thawed. Since the temporary space S3 is present between the second solution 8 and the opening 7a, even though a part of the thawed second solution 8 moves toward the opening 7a, a part of the second solution 8 is housed in the temporary space S3. While the second solution 8 is thawed, the air present in the space S4 expands due to a temperature rise of the air present in the space S4. When the air present in the space S4 expands, the thawed second solution 8 moves toward the opening 7a and the volume of the temporary space S3 decreases. However, the temporary space S3 is still present between the second solution 8 and the opening 7a after the movement. In a state where the thawing of the second solution 8 is completed, the thawed second solution 8 may reach the opening 7a. That is, in a state where the thawing of the second solution 8 is completed, there may be no space between the second solution 8 and the opening 7a. Step S25 may be performed simultaneously with at least one of steps S22 to S24.

In step S26, the thawed second solution 8 is led out from the opening 7a and is added to the first internal space S1 via the opening 4a. In step S26, a content from a predetermined position on a side opposite to the opening 7a with respect to the second solution 8 in the second internal space S2 to the opening 7a is led out from the opening 7a. The predetermined position is a position between the surface 8b of the second solution 8 and the opening 7b. That is, the predetermined position is spaced apart from the surface 8b of the second solution 8. In step S26, a content having a volume larger than a sum of the volume of the thawed second solution 8 and the volume of the temporary space S3 is led out from the opening 7a. In step S26, air is discharged from the nozzle 93. The volume of the discharged air is larger than the sum of the volume of the thawed second solution 8 and the volume of the temporary space S3. As a result, the second solution 8 and the content positioned closer to the opening 7a than the second solution 8 are reliably led out from the opening 7a. In step S26, the second solution 8 may be added to the first internal space S1 in a state where the temperature of the second solution 8 is maintained at an appropriate temperature (optimum temperature) for the stimulant.

In step S27, the light generated in the first internal space S1 and transmitted through the light-transmissive region 4b of the first container 4 is measured. In step S27, the excitation light is continuously emitted to the first internal space S1, and the light generated in the first internal space S1 is continuously detected. Irradiation of the excitation light and detection of the light start before step S26. That is, the irradiation of the excitation light and the detection of the light start before the addition of the second solution 8 to the first container 4.

When the first internal space S1 in which the reaction between the fluorescent indicator of the first solution 6 and the HOCl generated from the biological sample is in progress is irradiated with excitation light having a wavelength of 480 nm, fluorescence having a wavelength of 515 nm is generated in the first internal space S1. In step S27, fluorescence having a wavelength of 515 nm is detected. As a result, the myeloperoxidase activity is measured.

Although an embodiment of the present disclosure has been described above, the present disclosure is not limited to the above-described embodiment.

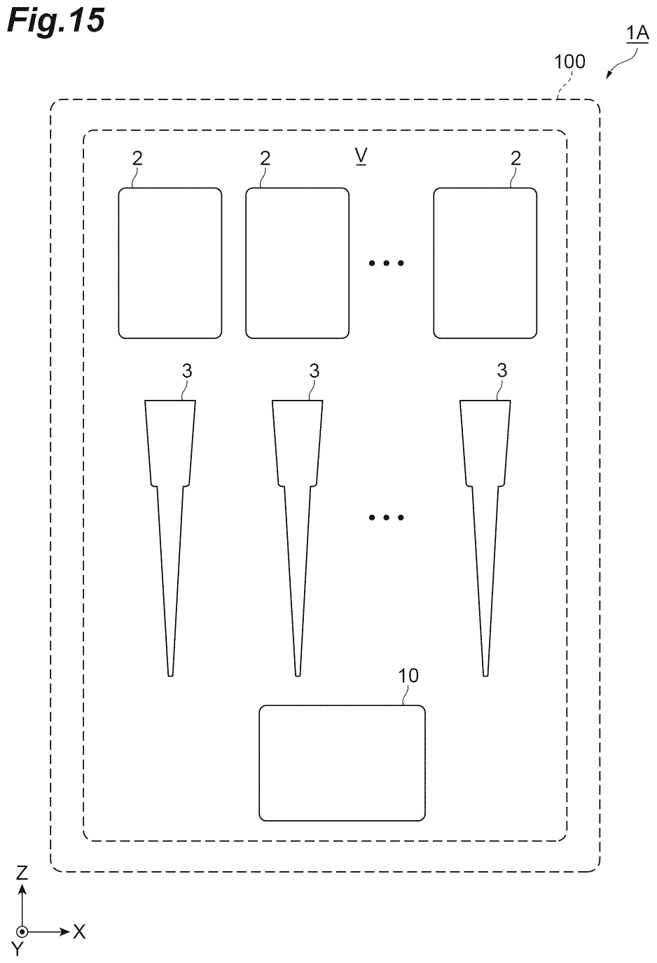

In the embodiment described above, as illustrated in FIG. 1, the case where one first measurement kit 2, one second measurement kit 3, and one moisture absorbent 10 are housed in the internal space V of the sealing bag 100 has been described. However, the number of each of the first measurement kit 2, the second measurement kit 3, and the moisture absorbent 10 housed in the internal space V of the sealing bag 100 is not limited to one. For example, a measurement unit 1A illustrated in FIG. 15 includes a plurality of first measurement kits 2 and a plurality of second measurement kits 3, and the plurality of first measurement kits 2 and the plurality of second measurement kits 3 are housed in the internal space V of the sealing bag 100. In the internal space V of the sealing bag 100, the number of the plurality of first measurement kits 2 is the same as the number of the plurality of second measurement kits 3.

When the plurality of first measurement kits 2 and the plurality of second measurement kits 3 are housed in the internal space V of the sealing bag 100 as in the measurement unit 1A, it is possible to reduce the cost required for the production, transportation, and the like of the measurement unit 1A by collectively housing the plurality of containers in the internal space of the sealing bag at the time of mass-producing the frozen containers. The measurement unit 1A may include a plurality of moisture absorbents 10. In the measurement unit 1A, the number of the plurality of first measurement kits 2 may be different from the number of the plurality of second measurement kits 3.

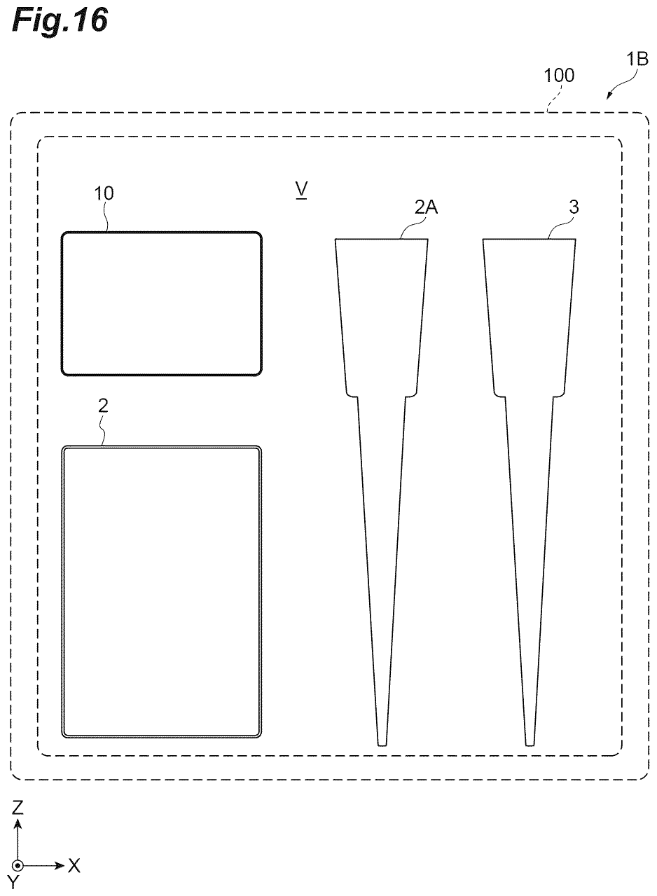

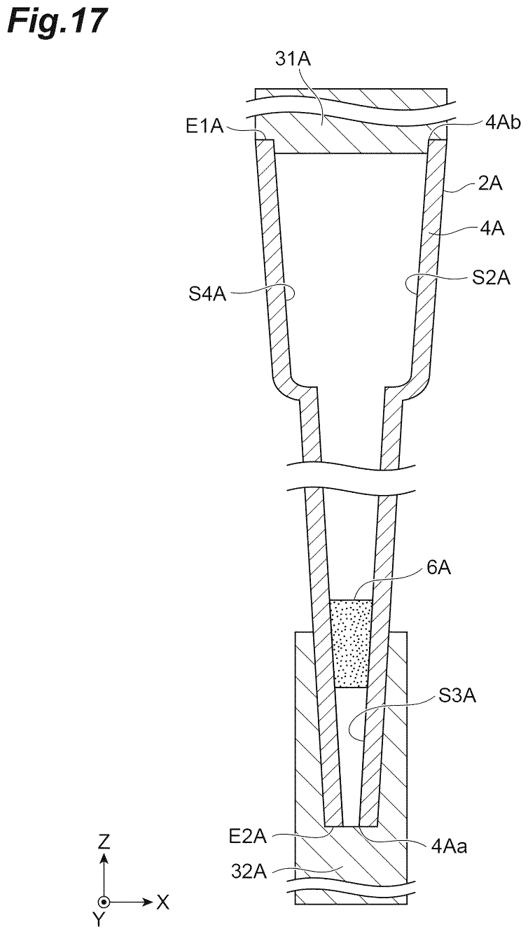

As in a measurement unit 1B illustrated in FIG. 16, a third measurement kit 2A may be housed in the internal space V of the sealing bag 100 in addition to the first measurement kit 2, the second measurement kit 3, and the moisture absorbent 10. As illustrated in FIG. 17, the third measurement kit 2A includes a third container 4A, a third solution 6A, a first sealing member 31A, and a second sealing member 32A. In the measurement unit 1B, the first solution 6 housed in the first container 4 of the first measurement kit 2 contains at least one of physiological saline and a buffer solution, and does not contain a fluorescent indicator. The fluorescent indicator is contained in the third solution 6A housed in the third container 4A of the third measurement kit 2A. Therefore, in the internal space V of the sealing bag 100 of the measurement unit 1B, the first solution 6 containing at least one of physiological saline and a buffer solution, and the third solution 6A containing the fluorescent indicator are housed in separate containers.

The third container 4A for housing the third solution 6A containing the fluorescent indicator has, for example, the same configuration as the second container 7 (see FIG. 6) of the second measurement kit 3. As illustrated in FIG. 17, the third container 4A has, for example, a conical shape with a center line parallel to the Z-axis direction, and has elasticity. The third container 4A includes a second internal space S2A, an opening 4Aa, and an opening 4Ab. The opening 4Aa and the opening 4Ab are formed at positions facing each other in the third container 4A. For example, the opening 4Ab is formed at a first end E1A of the third container 4A in the Z-axis direction. The opening 4Aa is formed at a second end E2A of the third container 4A in the Z-axis direction. Each of the opening 4Aa and the opening 4Ab is connected to the second internal space S2A. The second internal space S2A has, for example, a conical shape. A cross-sectional area of the second internal space S2A decreases from the opening 4Ab toward the opening 4Aa. A diameter of the opening 4Aa is smaller than a diameter of the opening 4Ab. The opening 4Aa is a discharge port of the third container 4A. The opening 4Aa may function as a suction port of the third container 4A. The third container 4A is, for example, a pipette tip.

The third solution 6A is housed in the second internal space S2A. The third solution 6A fills a part of the second internal space S2A. A temporary space S3A is present between the third solution 6A and the opening 4Aa, and a space S4A is present between the third solution 6A and the opening 4Ab. Specifically, the third solution 6A is positioned inside each of the opening 4Aa and the opening 4Ab.

The third solution 6A is cooled in a state of being housed in the second internal space S2A. In this example, a case is illustrated where the third solution 6A is cooled to an extent that it is not frozen in a state of being housed in the second internal space S2A. The third solution 6A may be frozen in a state of being housed in the second internal space S2A. In this case, the third solution 6A may be frozen, for example, in a state where the temporary space S3A is present between the third solution 6A and the opening 4Aa and the space S4A is present between the third solution 6A and the opening 4Ab. In this case, the third solution 6A may be entirely frozen or partially frozen. The temperature of the third solution 6A may be, for example, the same as the temperature of the first solution 6. The temperature of the third solution 6A may be, for example, −20° C. The temperature of the third solution 6A may be lower than the temperature of the first solution 6. The temperature of the third solution 6A may be, for example, −30° C. or lower, −40° C. or lower, or −80° C. or lower.

The first sealing member 31A has, for example, the same configuration as the first sealing member 31 of the second measurement kit 3. The first sealing member 31A is disposed so as to close the opening 4Ab of the third container 4A. The first sealing member 31A fills the opening 4Ab of the third container 4A without any gap. The first sealing member 31A may be in contact with the first end E1A of the third container 4A or may not be in contact with the first end E1A of the third container 4A. The first sealing member 31A is detachably attached to the third container 4A.

The second sealing member 32A has, for example, the same configuration as the second sealing member 32 of the second measurement kit 3. The second sealing member 32A is disposed so as to close the opening 4Aa of the third container 4A located on the side opposite to the opening 4Ab. The second sealing member 32A may be in contact with the second end E2A of the third container 4A or may not be in contact with the second end E2A of the third container 4A. A space may be formed between the second sealing member 32A and the second end E2A of the third container 4A. The second sealing member 32A may fill the opening 4Aa of the third container 4A without any gap. The second sealing member 32A is detachably attached to the third container 4A.

The first sealing member 31A and the second sealing member 32A close the opening 4Aa and the opening 4Ab of the third container 4A, respectively, so that the second internal space S2A of the third container 4A is sealed. When the third measurement kit 2A is housed in the internal space V of the sealing bag 100 illustrated in FIG. 16, for example, the third measurement kit 2A is housed in the internal space V in a state where the cooled third solution 6A is housed in the second internal space S2A and the openings 4Ab and 4Aa are closed by the first sealing member 31A and the second sealing member 32A. Depending on the temperature of the third solution 6A, the first sealing member 31A may come off from the opening 4Ab of the third container 4A. Therefore, the measurement unit 1B may not include the first sealing member 31A that closes the opening 4Ab of the third container 4A. That is, in a state where the third container 4A is housed in the internal space V of the sealing bag 100, the opening 4Ab of the third container 4A may be open without being closed by the first sealing member 31A.

As in the measurement unit 1B, when the first solution 6 containing at least one of physiological saline and a buffer solution and the third solution 6A containing the fluorescent indicator are housed in separate containers in the internal space V of the sealing bag 100, the quality of the solution housed in each container is less likely to deteriorate than in a case where at least one of physiological saline and a buffer solution, and the fluorescent indicator are housed in one container, so that the quality of each solution can be more reliably maintained.

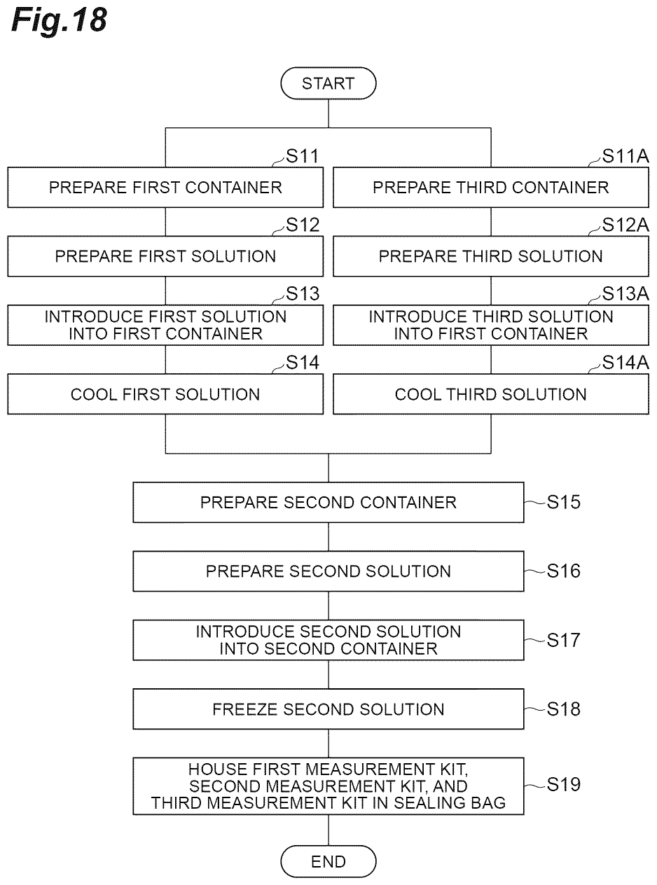

As illustrated in FIG. 18, when the measurement unit 1B is manufactured, steps S11A to S14A are performed in addition to the above-described steps S11 to S19. In step S12 of FIG. 18, the first solution 6 containing at least one of physiological saline and a buffer solution and not containing a fluorescent indicator is prepared. The order of steps S11A to S14A is not limited to the example illustrated in FIG. 18, and may be arbitrarily changed. Steps S11A to S14A are performed, for example, in parallel with steps S11 to S14. At least one of steps S11A to S14A may be performed simultaneously with at least one of steps S11 to S14, or may be performed before or after steps S11 to S14.

In step S11A, the third container 4A is prepared. In step S12A, the third solution 6A is prepared. The third solution 6A contains at least a fluorescent indicator. In step S13A, the third solution 6A prepared in advance is introduced into the second internal space S2A of the third container 4A. Subsequently, in step S14A, the third solution 6A is cooled to an extent that it is not frozen in a state of being housed in the second internal space S2A. The third solution 6A may be cooled to, for example, about −20° C. in a state of being housed in the second internal space S2A. As a result, the third measurement kit 2A in which the third solution 6A is cooled is manufactured. In step S14A, the third solution 6A may be frozen in a state of being housed in the second internal space S2A. If the fluorescent indicator is left in a room temperature environment for a long time, the quality of the fluorescent indicator may be affected. Therefore, it is desirable that the third solution 6A be managed in an environment close to the manufacturing environment of the second measurement kit 3. That is, it is desirable that steps S11A, S12A and S13A be performed in a state of being cooled to some extent, that is, in a low-temperature environment. For example, steps S11A, S12A and S13A may be performed using the cold storage box B1 or the cold storage box B2 as illustrated in FIGS. 9A, 9B, and 9C in a manner similar to the manufacturing process of the second measurement kit 3. However, the temperature management of the third solution 6A does not need to be as strict as in the case of the second solution 8, which is a stimulant particularly concerned about deterioration due to hydrolysis, and may be performed in a temperature range (for example, 4° C. or less) in which the quality of the fluorescent indicator is maintained.

Subsequently, steps S15 to S19 are performed. In step S19, as illustrated in FIG. 16, the first measurement kit 2, the second measurement kit 3, and the third measurement kit 2A are housed in the internal space V of the sealing bag 100 together with the moisture absorbent 10. In the sealed internal space V, the first solution 6 housed in the first container 4, the second solution 8 housed in the second container 7, and the third solution 6A housed in the third container 4A are, for example, in a frozen state. In this state, the opening 7b and the opening 7a of the second container 7 are closed by the first sealing member 31 and the second sealing member 32, respectively, and the opening 4Ab and the opening 4Aa of the third container 4A are closed by the first sealing member 31A and the second sealing member 32A, respectively. By the manufacturing method described above, the measurement unit 1B having the above-described effects can be manufactured. Inside the sealing bag 100, the first measurement kit 2, and the second measurement kit 3 and the third measurement kit 2A may be housed in separate spaces partitioned from each other. That is, inside the sealing bag 100, one space for housing the first container 4 and one space for housing the second container 7 and the third container 4A may be partitioned from each other. For example, the sealing bag 100 may be partitioned in advance by a sealer or the like, or the second measurement kit 3 and the third measurement kit 2A may be housed in a sealing bag having a size smaller than that of the sealing bag 100. In that case, the moisture absorbent 10 may be housed in the same space as the second measurement kit 3 and the third measurement kit 2A inside the sealing bag 100. The moisture absorbent 10 may not be provided inside the sealing bag 100.

In the embodiment and examples described above, although it has been described that the subject is the human body, the subject may be, for example, an animal or the like. An example in which the biological sample is blood of a subject is shown. The biological sample may be, for example, a body fluid of a subject or the like. The biological sample may be, for example, saliva, perfusate, tears, sweat, urine, or the like of the subject. Examples of the activity of neutrophils were illustrated as characteristics of the biological sample. The characteristics of the biological sample may be, for example, an activity of a tissue cell such as monocyte, eosinophil, basophil, B cell, T cell, NK cell, or vascular endothelial cell.

In the above-described embodiment and examples, an example in which the first solution 6 and the third solution 6A contain a fluorescent indicator has been described. The first solution 6 and the third solution 6A may include a chemiluminescent indicator. The chemiluminescent indicator reacts with a component (superoxide) generated from the biological sample. The chemiluminescent indicator is, for example, 2-methyl-6-(4-methoxyphenyl)-3,7-dihydroimidazo[1,2-a]pyrazin-3-one (MCLA) or the like. A commercially available product may be used as the chemiluminescent indicator. In the first internal space S1 where the reaction between the superoxide generated from the biological sample and the chemiluminescent indicator of the first solution 6 is in progress, chemiluminescence having a maximum emission wavelength of 465 nm is generated. In step S27, the chemiluminescence having the maximum emission wavelength of 465 nm may be detected. As a result, the superoxide production activity is measured.

In the above-described embodiment and examples, an example in which the second container 7 and the third container 4A are pipette tips has been described. The second container 7 and the third container 4A may be, for example, a capillary nozzle, a dropper, a volumetric, a Komagome pipette, a graduated pipette, a hematocrit capillary, a syringe, or the like.

In the above-described embodiment and examples, an example has been described in which the volume of the temporary space S3 is equal to or larger than the volume of the second solution 8. The volume of the temporary space S3 may be smaller than the volume of the second solution 8.

In the above-described embodiment and examples, it has been described that the second solution 8 is introduced into the second internal space S2 by the suction nozzle inserted into the opening 7b of the second container 7. The second solution 8 may be introduced into the second internal space S2 by the suction force of the second container 7 itself. Specifically, first, the opening 7b of the second container 7 is closed. Subsequently, for example, the second container 7 is pressurized from the outside of the second container 7 by the hand of an operator. As a result, the air in the second internal space S2 is led out via the opening 7a. Subsequently, the second container 7 is disposed such that the opening 7a of the second container 7 comes into contact with the second solution 8. Subsequently, the pressurization by the hand of the operator is released. As a result, the second solution 8 is drawn into the second internal space S2 via the opening 7a.

For example, the first solution 6 and the third solution 6A may contain, as an indicator reacting with hypochlorous acid (or halogen equivalent thereof) produced by myeloperoxidase, taurine/TNB (see J. Clin. Invest., Vol. 70, pp. 598-607, 1982), 8-amino-5-chloro-7-phenylpyrido[3,4-d]pyridazine-1,4-(2H,3H)dione(L-012: see Anal Biochem., Vol. 271(1), pp. 53-58, 1999) or the like.

For example, the first solution 6 and the third solution 6A may contain, as an indicator reacting with a superoxide, 2-methyl-6-phenyl-3,7-dihydroimidazo[1,2-a]pyrazin-3-one (CLA), 2-methyl-6-p-methoxyphenylethynylimidazopyrazinone (MPEC), indocyanine-type imidazopyranodine compound (NIR-CLA), 2-[2,4,5,7-tetrafluoro-6-(2-nitro-4,5-dimethoxyphenylsulfonyloxy)-3-oxo-3H-xanthene-9-yl]benzoic acid (BES-So) or the like.

For example, the second solution 8 may contain, as a stimulant, opsonized zymosan (OZ). The moisture of DMSO as an organic solvent contained in the second solution 8 may be removed in advance using an organic solvent purification apparatus or a DMSO dehydration apparatus. As DMSO, super-dehydrated grade DMSO may be used.

In the above-described embodiment and examples, it has been described that the first solution 6 prepared in advance outside the first internal space S1 is introduced into the first internal space S1. The first solution 6 may be prepared inside the first internal space S1. For example, the plurality of reagents may be introduced into the first internal space S1 in a state of being separated from each other. The plurality of reagents may be sequentially or simultaneously introduced into the first internal space S1. The third solution 6A may be prepared outside the second internal space S2A and then introduced into the second internal space S2A, or may be prepared inside the second internal space S2A.

When the total amount of the amount of the buffer solution required for preparing the first solution 6 and the amount of the buffer solution required for preparing the second solution 8 is set as a specific predetermined amount, the predetermined amount of the buffer solution may be prepared in step S12 of preparing the first solution 6. In this case, in step S12, the first solution 6 containing the buffer solution necessary for the preparation of the first solution 6 and the buffer solution necessary for the preparation of the second solution 8 (i.e., containing a predetermined amount of the buffer solution) may be prepared. In step S13, the first solution 6 containing the predetermined amount of the buffer solution may be introduced into the first container 4. That is, an amount of the buffer solution necessary for preparing the second solution 8 may also be introduced into the first container 4 in advance in step S13. The amount of the buffer solution necessary for preparing the second solution 8 may be added to the first container 4 in step S26 before the addition of the second solution 8 to the first container 4. In these cases, the second solution 8 inside the second container 7 does not contain a buffer solution. In step S12, only the buffer solution in the amount necessary for the preparation of the first solution 6 may be prepared, and the first solution 6 containing only the amount of the buffer solution may be prepared. The amount of the buffer solution contained in the first solution 6 can be appropriately adjusted depending on whether the second solution 8 contains the buffer solution or the second solution 8 does not contain the buffer solution.

In the above-described embodiment and examples, the case where the second container 7 housing the frozen second solution 8 is housed in the internal space V of the sealing bag 100 has been described. The second container 7 containing the frozen stimulant may be housed in the internal space V of the sealing bag 100. Even when only the frozen stimulant is housed in the second container 7 and housed in the internal space V of the sealing bag 100, there is a concern that hydrolysis of the stimulant proceeds according to humidity. Therefore, when the second container 7 containing the frozen stimulant is housed in the internal space V of the sealing bag 100, moisture in the air around the second container 7 can be prevented from being absorbed by the stimulant, similarly to the above-described embodiment. This makes it possible to suppress deterioration in the quality of the stimulant due to the progress of hydrolysis.

In the above-described embodiment and examples, the case where the second measurement kit 3 includes the first sealing member 31 and the second sealing member 32 that respectively close the opening 7b and the opening 7a of the second container 7 has been described. Both the opening 7b and the opening 7a of the second container 7 do not need to be closed by the sealing member. That is, when the second measurement kit 3 includes the first sealing member 31 that closes the opening 7b of the second container 7, the second measurement kit 3 may not include the second sealing member 32 that closes the opening 7a of the second container 7, and the opening 7a of the second container 7 may be open. When the second measurement kit 3 includes the second sealing member 32 that closes the opening 7a of the second container 7, the second measurement kit 3 may not include the first sealing member 31 that closes the opening 7b of the second container 7, and the opening 7b of the second container 7 may be open. Even in such an aspect, moisture in the air can be prevented from being absorbed by the second solution 8 as in the above-described embodiment. This makes it possible to suppress deterioration in the quality of the second solution 8 due to the progress of hydrolysis.

The measurement device 9 (refer to FIGS. 12 and 13) may have an adjustment mechanism that adjusts the position of the nozzle 93 in the Z-axis direction (a vertical direction). In step S26, the second solution 8 may be added to the first solution 6 in a state where the opening 7a of the second container 7 (a distal end of the second container 7) is positioned between the opening 4a of the first container 4 and the surface (a liquid level) 6a of the first solution 6. A distance between the distal end of the second container 7 and the surface 6a of the first solution 6 may be, for example, 1 mm. In this case, scattering of the second solution 8 or disturbance of the surface 6a of the first solution 6 is suppressed, and as a result, deterioration in measurement accuracy of the characteristic of the biological sample is suppressed. Specifically, in a case where the second solution 8 does not contain the buffer solution, since the amount of the second solution 8 to be added tends to be very small, it is difficult to control the dropping of the second solution 8 using the nozzle 93 and the second container 7. Thus, as a result of an increase in discharge pressure of the air from the nozzle 93, the second solution 8 may be sprayed from the opening 7a of the second container 7. When the second solution 8 is sprayed from the opening 7a, the second solution 8 is scattered, and as a result, there is a possibility that the stimulant added to the first solution 6 becomes insufficient. When the second solution 8 is sprayed from the opening 7a, the surface 6a of the first solution 6 is disturbed due to air bubbles, and as a result, there is a possibility that scattered light is generated. The present inventors have succeeded in suppressing the deterioration in measurement accuracy of the characteristic of the biological sample due to the scattering of the second solution 8 or the disturbance of the surface 6a of the first solution 6 by optimizing the distance between the distal end of the second container 7 and the surface 6a of the first solution 6. The distance between the distal end of the second container 7 and the surface 6a of the first solution 6 may be adjusted based on the amount of the second solution 8 to be added, the discharge pressure of the air from the nozzle 93, or the like.

In step S17 (refer to FIG. 8) of the method for manufacturing the measurement unit 1, for example, micropipette or the like may be used as the suction nozzle. Specifically, first, a distal end of the micropipette is inserted into the opening 7b of the second container 7. Subsequently, the specified amount (e.g., 0.75 μL) of the second solution 8 is drawn into the second internal space S2 of the second container 7 via the opening 7a of the second container 7 by the suction force of the micropipette. Subsequently, in a state where the distal end of the micropipette is inserted into the opening 7b of the second container 7, the suction amount of the micropipette is increased to, for example, 3μL. As a result, a predetermined amount of air is further drawn into the second internal space S2 through the opening 7a.

What is claimed is:

1. A measurement unit used for measuring a characteristic of a biological sample, the unit comprising:
a solution containing a stimulant configured to activate a function of the biological sample and an organic solvent configured to dissolve the stimulant;
a container configured to house the frozen solution; and
a sealing bag configured to house the container in its sealed internal space.

2. The measurement unit according to claim 1, further comprising:
a sealing member configured to close at least one of a first opening formed in the container and a second opening formed in the container at a position different from the first opening.

3. The measurement unit according to claim 1, further comprising:
a first sealing member configured to close a first opening formed in the container; and
a second sealing member configured to close a second opening formed in the container at a position different from the first opening.

4. The measurement unit according to claim 1, further comprising:
a moisture absorbent that is housed in the internal space of the sealing bag together with the container and absorbs moisture in the air.

5. The measurement unit according to claim 1, wherein one said container is housed in the internal space of the sealing bag.

6. The measurement unit according to claim 1, further comprising:
a plurality of said containers each housing the frozen solution,
wherein a plurality of said containers are housed in the internal space of the sealing bag.

7. The measurement unit according to claim 1, further comprising:
a first solution containing an indicator configured to react with a component generated from the biological sample; and
a first container configured to house the first solution,
wherein the sealing bag houses the first container configured to house the first solution and a second container that is the container housing a second solution that is the solution in the internal space.

8. The measurement unit according to claim 1, further comprising:
a first solution containing at least one of physiological saline and a buffer solution;
a first container configured to house the first solution;
a third solution containing an indicator configured to react with a component generated from the biological sample; and
a third container configured to house the third solution,
wherein the sealing bag houses the first container configured to house the first solution, a second container that is the container housing a second solution that is the solution, and the third container configured to house the third solution in the internal space.

9. The measurement unit according to claim 7, wherein the indicator is a fluorescent indicator.

10. The measurement unit according to claim 1, wherein the organic solvent is DMSO (dimethyl sulfoxide).

11. A measurement unit used for measuring a characteristic of a biological sample, the unit comprising:
a stimulant configured to activate a function of the biological sample;
a container configured to house the frozen stimulant; and
a sealing bag configured to house the container in its sealed internal space.

12. A method for manufacturing a measurement unit for measuring a characteristic of a biological sample, the method comprising:
preparing a solution containing a stimulant configured to activate a function of the biological sample and an organic solvent configured to dissolve the stimulant, a container capable of housing the solution, and a sealing bag capable of housing the container;
freezing the solution in a state of being housed in the container; and
sealing an internal space of the sealing bag in a state where the container is housed in the internal space.

13. The method for manufacturing a measurement unit according to claim 12, wherein in the freezing the solution, the solution is frozen in a state where a first opening formed in the container is closed with a first sealing member and a second opening formed in the container at a position different from the first opening is closed with a second sealing member.

14. The method for manufacturing a measurement unit according to claim 12, wherein in the sealing the internal space of the sealing bag, the internal space is sealed in a state where a moisture absorbent that absorbs moisture in the air is housed in the internal space together with the container.

15. The method for manufacturing a measurement unit according to

12. further comprising:
housing a first solution containing an indicator configured to react with a component generated from the biological sample in a first container,
wherein in the sealing the internal space of the sealing bag, the internal space is sealed in a state where the first container configured to house the first solution and a second container that is the container configured to house a second solution that is the solution are housed in the internal space.

16. The method for manufacturing a measurement unit according to claim 12, further comprising:
housing a first solution containing at least one of physiological saline and a buffer solution in a first container; and
housing a third solution containing an indicator configured to react with a component generated from the biological sample in a third container,
wherein in the sealing the internal space of the sealing bag, the internal space is sealed in a state where the first container configured to house the first solution, a second container that is the container configured to house a second solution that is the solution, and the third container configured to house the third solution are housed in the internal space.

17. The method for manufacturing a measurement unit according to claim 12, wherein, except during the preparing the solution and introducing the solution into the container, temperature around the container is maintained at a freezing point of the organic solvent or less.

18. The method for manufacturing a measurement unit according to claim 12, wherein in the freezing the solution, the solution is frozen in a state where a moisture absorbent that absorbs moisture in the air is disposed around the container.

19. The method for manufacturing a measurement unit according to claim 12, wherein in the sealing the internal space of the sealing bag, the internal space of the sealing bag is sealed in a state where the atmosphere of the internal space is replaced with a nitrogen atmosphere.

20. The method for manufacturing a measurement unit according to claim 12, wherein in the sealing the internal space of the sealing bag, the internal space of the sealing bag is sealed in a state where the internal space is maintained under vacuum.
